(19) United States
(12) Patent Application Publication
(10) Pub. No.: US 2017/0155903 A1
(43) Pub. Date: Jun. 1, 2017

(54) METHOD, APPARATUS AND SYSTEM FOR ENCODING AND DECODING VIDEO DATA ACCORDING TO LOCAL LUMINANCE INTENSITY

(71) Applicant: CANON KABUSHIKI KAISHA, Tokyo (JP)

(72) Inventors: CHRISTOPHER JAMES ROSEWARNE, CONCORD WEST (AU); JONATHAN GAN, RYDE (AU); VOLODYMYR KOLESNIKOV, DEE WHY (AU)

(21) Appl. No.: 15/360,817

(22) Filed: Nov. 23, 2016

(30) Foreign Application Priority Data
Nov. 30, 2015 (AU) 2015261734

(51) Int. Cl. H04N 19/124; H04N 19/86; H04N 19/61; H04N 19/51; H04N 19/15; H04N 19/13; H04N 19/159

(52) U.S. Cl. CPC H04N 19/124; H04N 19/13; H04N 19/86; H04N 19/159; H04N 19/51; H04N 19/15; H04N 19/61; H04N 19/172

(57) ABSTRACT

A method of encoding a portion of a video frame into a video bitstream, in which the portion of the video frame contains samples, take account the samples representing luminance levels according to an EOTF. The method determines a luminance of the portion of the video frame, and a desired (environment) luminance step size. The desired luminance step size represents a just noticeable difference (JND) determined according to the determined luminance and a predetermined ambient luminance, the desired luminance step size being greater than a luminance (transfer function) step size from the EOTF. The method then determines a quantisation parameter from the desired luminance step size and the luminance step size from the EOTF, the quantisation parameter being used for encoding the portion of the video frame, and then encodes encoding the portion of the video frame into the video bitstream according to the determined quantisation parameter.

### REFERENCE TO RELATED APPLICATION(S)

This application claims the benefit under 35 U.S.C. §119 of the filing date of Australian Patent Application No. 2015261734, filed 30 Nov. 2015, hereby incorporated by reference in its entirety as if fully set forth herein.

### TECHNICAL FIELD

The present invention relates generally to digital video signal processing and, in particular, to a method, apparatus and system for encoding and decoding of video data with variation in quantisation according to local luminance intensity. The present invention also relates to a computer program product including a computer readable medium having recorded thereon a computer program for encoding and decoding video data with variation in quantisation according to local luminance intensity.

### BACKGROUND

Development of standards for conveying high dynamic range (HDR) and wide colour gamut (WCG) video data and development of displays capable of displaying HDR video data is underway. Standards bodies such as International Organisations for Standardisation/International Electrotechnical Commission Joint Technical Committee 1/Subcommittee 29/Working Group 11 (ISO/IEC JTC1/SC29/WG11), also known as the Moving Picture Experts Group (MPEG), the International Telecommunications Union-Radiocommunication Sector (ITU-R), the International Telecommunications Union-Telecommunication Sector (ITU-T), and the Society of Motion Picture Television Experts (SMPTE) are investigating the development of standards for representation and coding of HDR video data.

HDR video data covers a wide range of luminance intensities, far beyond that used in traditional standard dynamic range (SDR) services. For example, the Perceptual Quantizer (PQ) Electro-Optical Transfer Function (EOTF), standardised as SMPTE ST.2084, is defined to support a peak luminance of up to 10,000 candela/meter² (nits) whereas traditional television services are defined with a 100 nit peak brightness (although more modern sets increase the peak brightness beyond this). The minimum supported luminance is zero nits, but for the purposes of calculating the dynamic range the lowest non-zero luminance is used, i.e. 4*10⁻⁵ nits for PQ quantised to 10 bits.

The human visual system (HVS) is capable of perceiving luminance levels covering an enormous range of intensities using a temporal adaptation mechanism. However, at a given point in time the range of perceptible luminance levels is much less than the full range of perceptible luminance levels, allowing adaptation of the HVS to ambient conditions. Generally, adapting to an increased luminance level occurs more rapidly (in the order of a few minutes to adapt from a dark room to outside sunlight) than adapting to a decreased luminance level (in the order of thirty minutes to adapt from outside sunlight to a dark room).

When encoding video data, a quantisation parameter is used to adjust scaling of the video data in the transformed domain. A quantisation step size is derived from the quantisation parameter. Larger quantisation step sizes result in a reduction in the bit rate for a given sequence of video data, at a cost of greater loss of precision. Excessive loss of precision results in undesirable ‘banding’ artefacts, where the quantisation step size results in a luminance transitions between adjacent blocks within a frame that are visible to the human eye. Minimising the bit rate of a sequence without introducing banding artefacts is desirable, e.g. to reduce network usage when streaming encoded video data.

Quantisation is performed by a quantiser module. As alluded to previously, a quantiser is said to have a ‘step size’ that is controlled via a ‘quantisation parameter’ (or ‘QP’). The step size defines the ratio between the values output by the transform and the values encoded in a bitstream. At higher quantisation parameter values, the step size is larger, resulting in higher compression. The quantisation parameter may be fixed, or may be adaptively updated based on some quality or bit-rate criteria. Extreme cases of residual coefficient magnitude, resulting from a transform and quantisation parameter, define a ‘worst case’ for residual coefficients to be encoded and decoded from a bitstream. The relationship between the quantisation parameter and the step size approximates a power-of-two function, such that increasing the quantisation parameter by six results in a doubling of the step size. Modules within the video encoder and the video decoder separate the quantisation parameter into two portions, a ‘period’ (or ‘QP_per’) and a ‘remainder’ (or ‘QP_rem’). The remainder is the result of a modulo six of the quantisation parameter and the period is the result of an integer division by six of the quantisation parameter. The behaviour of these operations, including negative quantisation parameters, is exemplified in the Table 1, below:

TABLE 1

| | | | | | | | | | | | | | | | | | | |
|---|---|---|---|---|---|---|---|---|---|---|---|---|---|---|---|---|---|---|
| QP | . . . | −8 | −7 | −6 | −5 | −4 | −3 | −2 | −1 | 0 | 1 | 2 | 3 | 4 | 5 | 6 | 7 | . . . |
| QP_per | . . . | −2 | −2 | −1 | −1 | −1 | −1 | −1 | −1 | 0 | 0 | 0 | 0 | 0 | 0 | 1 | 1 | . . . |
| QP_rem | . . . | 4 | 5 | 0 | 1 | 2 | 3 | 4 | 5 | 0 | 1 | 2 | 3 | 4 | 5 | 0 | 1 | . . . |

### SUMMARY

It is an object of the present invention to substantially overcome, or at least ameliorate, one or more disadvantages of existing arrangements.

According to one aspect of the present disclosure, there is provided a method of encoding a portion of a video frame into a video bitstream, the portion of the video frame containing samples, the samples representing luminance levels according to an EOTF, the method comprising determining a luminance of the portion of the video frame, determining a desired luminance step size, the desired luminance step size being a just noticeable difference (JND) determined according to the determined luminance and a predetermined ambient luminance, the desired luminance step size being greater than a luminance step size from the EOTF. The method continues with determining a quantisation parameter from the desired luminance step size and the luminance step size from the EOTF, the quantisation parameter being used for encoding the portion of the video frame and encoding the portion of the video frame into the video bitstream according to the determined quantisation parameter.

Typically the portion of the video frame corresponds with one coding tree unit.

Desirably the quantisation parameter is determined from a provided quantisation parameter such that a quantisation step size is adjusted according to a ratio between the desired luminance step size and the luminance step size from the EOTF.

In a preferred implementation the EOTF is the PQ-EOTF.

Advantageously, the ambient luminance is also encoded into the video bitstream.

Most desirably the luminance step size from the EOTF is determined using the Barten contrast sensitivity function (CSF) adjusted for differences between a representative luminance value and the ambient luminance. More preferably the representative luminance comprises one of an average luminance or a modified luminance based on the average luminance and a standard deviation.

In another example, the quantisation parameter (QP) is adjusted using a delta quantisation parameter. Preferably, the QP is adjusted for each portion of the video frame and encoded into a transform unit of the bitstream. Alternatively, or additionally, the adjusting of the quantisation parameter includes adjusting one or more quantisation matrices.

According to another aspect, disclosed is a video system, comprising a video encoder arranged to encode at least a portion of a video frame into a video bitstream, the portion of the video frame containing samples representing luminance levels according to an EOTF, the encoder being operable to determine a luminance of the portion of the video frame, determine a desired luminance step size, the desired luminance step size being a just noticeable difference (JND) determined according to the determined luminance and a predetermined ambient luminance, the desired luminance step size being greater than a luminance step size from the EOTF. The encoder being operable to determine a quantisation parameter from the desired luminance step size and the luminance step size from the EOTF, the quantisation parameter being used for encoding the portion of the video frame and encode the portion of the video frame into the video bitstream according to the determined quantisation parameter. The video system includes a path by which the video bitstream is conveyed; and at least one video decoder operable to decode the video bitstream conveyed by the path and to provide a decoded video signal for reproduction upon panel device.

Other aspects are also disclosed.

### BRIEF DESCRIPTION OF THE DRAWINGS

At least one embodiment of the present invention will now be described with reference to the following drawings and appendices, in which:

FIG. 1 is a schematic block diagram showing a video capture and reproduction system that includes a video encoder and a video decoder;

FIGS. 2A and 2B collectively form a schematic block diagram of a general purpose computer system upon which one or both of the video capture device and display device of FIG. 1 may be practiced;

FIGS. 2A and 2B form a schematic block diagram of a general purpose computer system upon which one or both of the video encoding and decoding system of FIG. 1 may be practiced;

FIG. 3 depicts an exemplary viewing environment for video display or mastering;

FIG. 4A shows the relationship between absolute luminance and the corresponding contrast step, for various transfer functions encoding at a particular bit depth;

FIG. 4B shows the perceptual-quantiser (PQ) electro-optical transfer function (EOTF);

FIG. 5 shows a decomposition of a coding tree unit (CTU) into a number of coding units (CUs) and transform units (TUs);

FIG. 6 is a schematic block diagram showing the video encoder of FIG. 1;

FIG. 7 is a schematic block diagram showing the quantiser module of FIG. 6;

FIG. 8 is a schematic block diagram showing the video decoder of FIG. 1;

FIG. 9 is a schematic flow diagram showing a method for encoding video data;

FIG. 10 is a schematic flow diagram showing a method for decoding video data;

FIGS. 11A and 11B depict a method for rate-distortion optimised quantisation with reduced bit rate and no subjective impairment;

FIG. 12 includes a graph showing various statistical distributions of luminance over a portion of a frame of video data.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

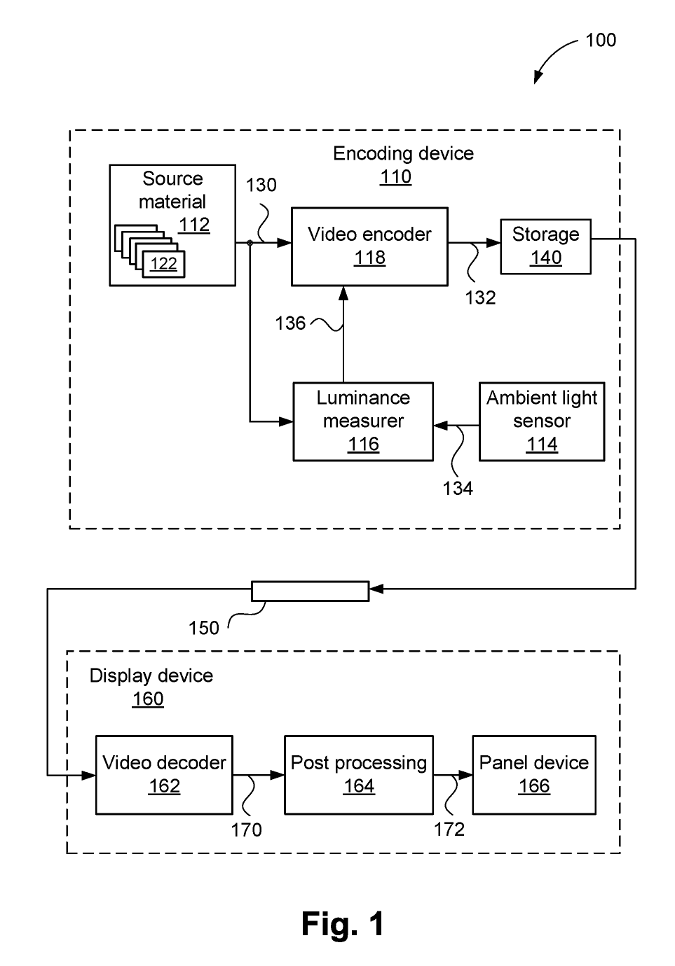

FIG. 1 is a schematic block diagram showing functional modules of a video encoding and decoding system 100. The system 100 includes an encoding device 110, such as a digital video camera, a display device 160, and a communication channel 150 interconnecting the two. The encoding device 110 typically operates in a ‘capture environment’ to capture video data. The encoding device 110 may also include ‘mastering’, whereby editing of video data happens prior to transmission over the communication channel 150. In such a case, a ‘mastering environment’ is said to exist, the mastering environment being different to the capture environment and representative of the intended viewing conditions for the video data. Generally, the encoding device 110 operates at a separate location (and time) to the display device 160. As such, the system 100 generally includes separate devices operating at different times and locations. In mastering environments, the display device 160 will be co-located with the encoding device 110, and additional instances of the display device 160 (also considered part of the video encoding and decoding system 100) are present for each recipient of the encoded video data, e.g. customers of a video streaming service or viewers of a free to air broadcast service.

The encoding device 110 encodes source material 112. The source material 112 may be obtained from a complementary metal oxide semiconductor (CMOS) imaging sensor of a video camera with a capability to receive a wider range of luminance levels than traditional SDR imaging sensors. Additionally, the source material 112 may also be obtained using other technologies, such as charged coupled device (CCD) technology, or generated from computer graphics software, or some combination of these sources. For the ‘mastering’ implementations, the source material 112 may simply represent previously captured and stored video data.

The source material 112 includes a sequence of frames 122. Collectively, the frames 122 form uncompressed video data 130. The video data 130 includes codewords for the frames 122. The source material 112 is generally sampled as tri-stimulus values in the RGB domain, representing linear light levels. Conversion of linear light RGB to a more perceptually uniform space is achieved by the application of a non-linear transfer function and results in R′G′B′ representation. The transfer function may be an opto-electrical transfer function (OETF), in which case the R′G′B′ values represent physical light levels of the original scene. In such arrangements, the video processing system 100 may be termed a ‘scene-referred’ system. Alternatively, the transfer function may be the inverse of an electro-optical transfer function (EOTF), in which case the R′G′B′ values represent physical light levels to be displayed. In such arrangements, the video processing system 100 may be termed a ‘display-referred’ system. The R′G′B′ representation is then converted to a colour space that decorrelates the luminance from each of R′, G′ and B′, such as YCbCr. Note that application of the colour space conversion on R′G′B′, rather than RGB, results in some distortions, but is an accepted practice in television and video systems known as ‘non-constant luminance’ (NCL). The YCbCr representation is then quantised to a specified bit depth, resulting in discrete ‘codewords’. Codewords in the ‘Y’ channel encode, approximately, the luminance levels present in the source material 112 according to the transfer function. The range of distinct codewords is implied by the bit depth in use. Generally, the video processing system 100 operates at a particular bit depth, such as 10 bits. Operation at this bit depth implies the availability of 1024 discrete codewords. Further restriction upon the range of available samples may also be present. For example, if the uncompressed video data 130 is to be transported within the encoding device 110 using the ‘serial digital interface’ (SDI) protocol, the codeword range is restricted to 4-1019 inclusive, giving 1016 discrete codeword values. Alternatively, TV broadcast systems may limit the codeword range to 64-940 for 10-bit video data.

Prior to encoding, the uncompressed video data 130 is generally edited, or ‘mastered’, to achieve a desired aesthetic. The mastering may include brightness, contrast, and colour adjustment. Mastering takes place in an environment with controlled lighting conditions. In particular, the ambient illumination may be set to a specific level of luminance and calibrated to a specific colour. For example, when mastering for TV broadcast, the ambient illumination may be set to 10 nits and D65 colour. The D65 colour corresponds to a chromaticity coordinate of (0.31270, 0.32900) in the CIE1931 colour space defined by the International Commission on Illumination (CIE). When mastering for cinema, the ambient illumination may be set to 0.1 nits and a colour corresponding to chromaticity coordinate (0.31400, 0.35100) in the CIE1931 colour space. A means of specifying, or detecting, the ambient light level, such as an ambient light sensor 114, is provided in the encoding device 110.

A luminance measurer module 116 measures the luminance in a portion of a frame of the uncompressed video data 130. The portion may be a section of the frame currently being encoded by the video encoder 118. The measurement of the luminance may be achieved by averaging the linear light levels corresponding to each codeword of the portion of the frame of the uncompressed video data 130, either by averaging prior to application of the transfer function, or applying the inverse transfer function to each codeword and then averaging. An advantage of this arrangement is that the luminance average is calculated in a manner that matches the physical processes of the human visual system (HVS). Alternatively, the luminance may be estimated by averaging the codewords directly, and then applying the inverse transfer function to the averaged result. An advantage of this arrangement is reduced complexity, as the average is applied to integer values, and the inverse transfer function need only apply once per CTU, if converting the averaged codeword value back to a linear light value. The luminance measurer module 116 produces a representative luminance measure 136, which may be the simple average of the linear light. The luminance measurer also obtains an estimate or measurement of an ambient environment illumination level 134, e.g. as measured from the ambient light sensor 114. The luminance measure 136 may provide additional statistical information regarding the composition of the portion of the frame under consideration. For example, a standard deviation or variance, or skew or kurtosis, may also be included in the luminance measure 136. Such additional information allows for more accurate characterisation of the contents of the portion of the frame of the uncompressed video data 130. For even greater characterisation, a histogram of the light values may be produced.

The ambient environment illumination 134 may alternatively be predetermined, for example in a mastering environment, in which case the ambient light sensor 114 can be omitted. Suitable values for a predetermined ambient environment illumination are specified. One example is ITU-R BT.2035, which specifies 10 lux illumination, with a background behind and surrounding the display device 160 of ˜10% of the reference white level, generally 10% of 100 nits=10 nits.

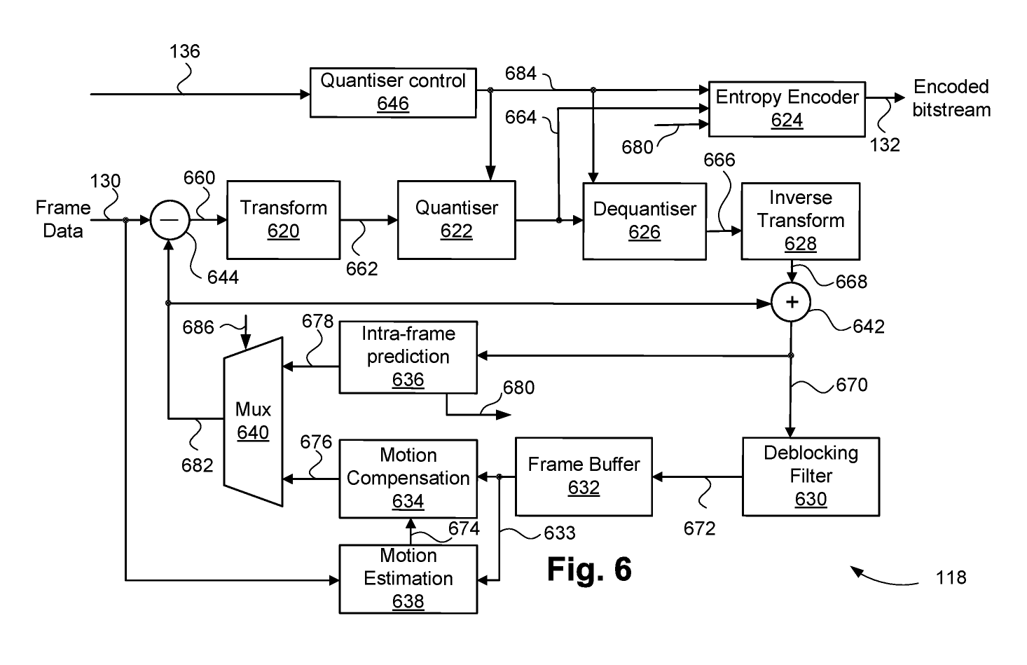

The video encoder 118 encodes each frame as a sequence of square regions, known as ‘coding tree units’, producing a encoded bitstream 132. Operation of the video encoder 118 is described with reference to FIG. 6 below. The encoded bitstream 132 can be stored, e.g. in non-transitory storage device or arrangement 140, prior to transmission over the communication channel 150.

The encoded bitstream 132 is conveyed (e.g. transmitted or passed) to the display device 160. Examples of the display device 160 include an LCD television, a monitor or a projector. The display device 160 includes a video decoder 162 that decodes the encoded bitstream 132 to produce decoded codewords 170. The decoded codewords 170 correspond approximately to the codewords of the uncompressed video data 130. The decoded codewords 170 are not exactly equal to the codewords of the uncompressed video data 130 due to lossy compression techniques applied in the video encoder 118. The decoded codewords 170 are passed to a post processing module 164 to produce a drive signal 172. The drive signal 172 is passed as input to the panel display 166 for visual reproduction of the video data. For example the reproduction may modulate the amount of backlight illumination passing through an LCD panel. The panel device 166 is generally an LCD panel with an LED backlight. The LED backlight may include an array of LEDs to enable a degree of spatially localised control of the maximum achievable luminance. The panel device 166 may alternatively use ‘organic LEDs’ (OLEDs). The relationship between a given codeword of the decoded codewords 170 and the corresponding light output emitted from the corresponding pixel in the panel device 166 is nominally the inverse of the transfer function. For a display-referred system, the inverse of the transfer function is the EOTF. For a scene-referred system, the inverse of the transfer function is the inverse OETF. For relative luminance systems, the light output is not controlled only by the codeword and the inverse of the transfer function. The light output may be further modified by user control of the contrast or brightness settings of the display, such as the panel device 166.

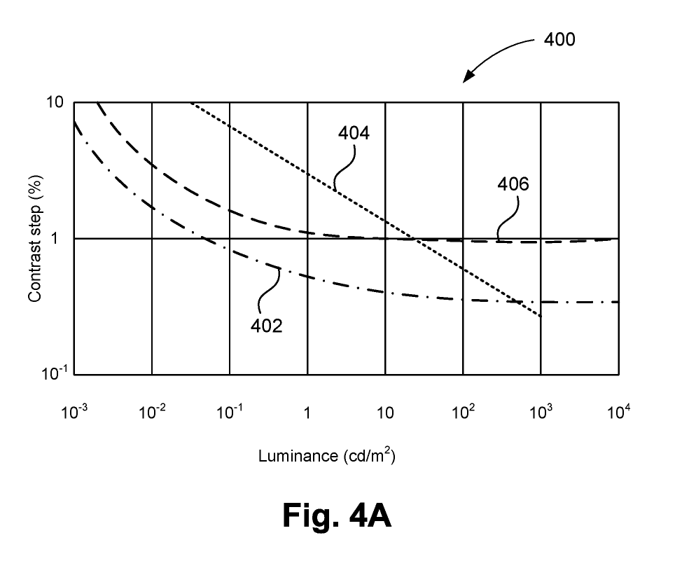

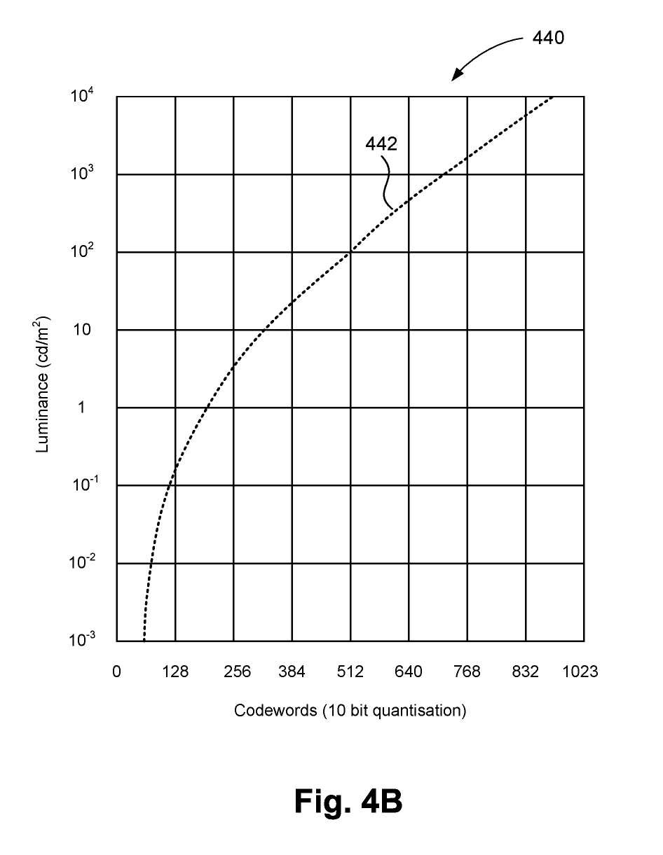

In one arrangement of the video processing system 100, the EOTF in use is the PQ-EOTF (SMPTE ST.2084), described further with reference to FIGS. 4A and 4B. Another example of a transfer function designed for the carriage of HDR video data is the Hybrid Log Gamma (HLG) Opto-Electrical Transfer Function (OETF), standardised as ARIB STD B-67. The HLG-OETF is nominally defined to support a peak luminance of 1,200 nits. However, as the HLG-OETF is a relative luminance transfer function, the viewer may adjust the contrast and brightness settings of the display device to display brighter luminances than the nominal peak luminance.

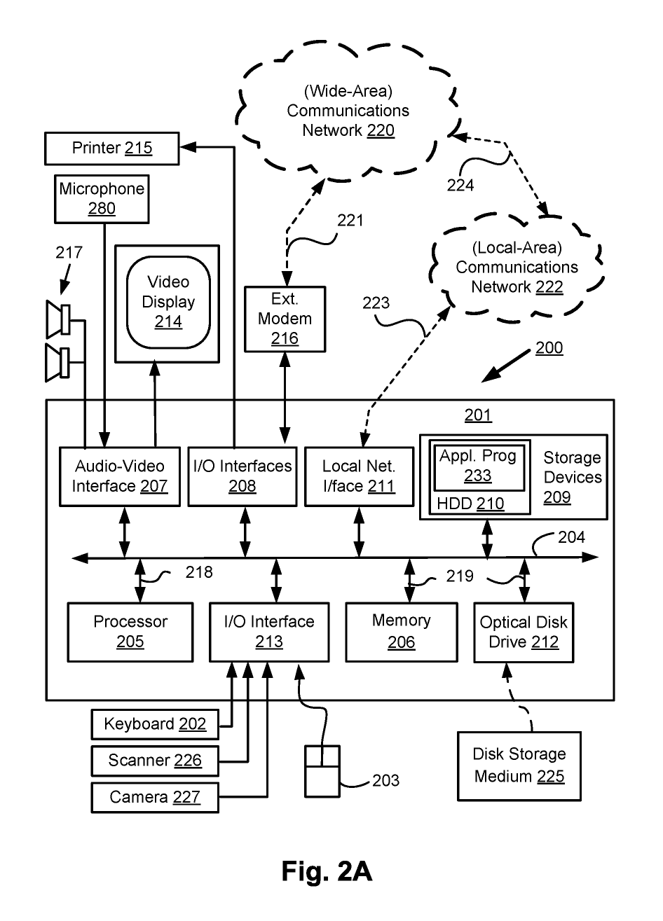

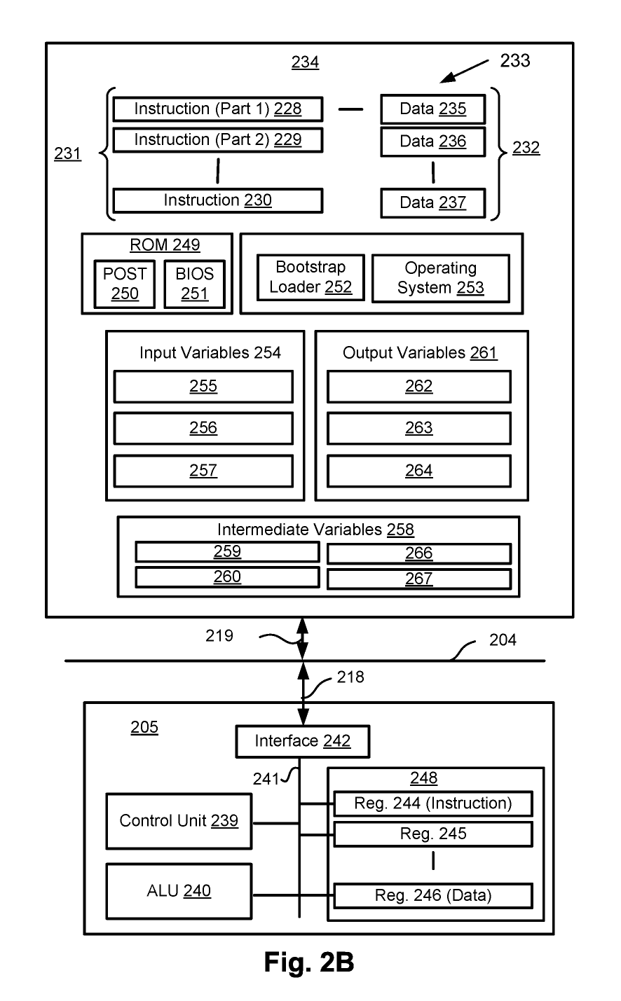

Notwithstanding the example devices mentioned above, each of the source device 110 and display device 160 may be configured within a general purpose computing system, typically through a combination of hardware and software components. FIG. 2A illustrates such a computer system 200, which includes: a computer module 201; input devices such as a keyboard 202, a mouse pointer device 203, a scanner 226, a digital video camera 227, which may be configured as the HDR imaging sensor 112, and a microphone 280, which may be integrated with the camera; and output devices including a printer 215, a display device 214, which may be configured as the display device 160, and loudspeakers 217. An external Modulator-Demodulator (Modem) transceiver device 216 may be used by the computer module 201 for communicating to and from a communications network 220 via a connection 221. The communications network 220, which may represent the communication channel 150, may be a wide-area network (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the communications network 220. The transceiver device 216 may additionally be provided in the capture device 110 and the display device 160 and the communication channel 150 may be embodied in the connection 221.

Further, whilst the communication channel 150 of FIG. 1 may typically be implemented by a wired or wireless communications network, the bitstream 132 may alternatively be conveyed between the encoding device 110 and the display device 160 by way of being recorded to a non-transitory memory storage medium, such as a CD or DVD. In this fashion the network 150 is merely representative of one path via which the bitstream 132 is conveyed between the encoding device 110 and the display device 160, with the storage media being another such path.

The computer module 201 typically includes at least one processor unit 205, and a memory unit 206. For example, the memory unit 206 may have semiconductor random access memory (RAM) and semiconductor read only memory (ROM). The computer module 201 also includes an number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. The signal from the audio-video interface 207 to the computer monitor 214 is generally the output of a computer graphics card. In some implementations, the modem 216 may be incorporated within the computer module 201, for example within the interface 208. The computer module 201 also has a local network interface 211, which permits coupling of the computer system 200 via a connection 223 to a local-area communications network 222, known as a Local Area Network (LAN). As illustrated in FIG. 2A, the local communications network 222 may also couple to the wide network 220 via a connection 224, which would typically include a so-called “firewall” device or device of similar functionality. The local network interface 211 may comprise an Ethernet™ circuit card, a Bluetooth™ wireless arrangement or an IEEE 802.11 wireless arrangement; however, numerous other types of interfaces may be practiced for the interface 211. The local network interface 211 may also provide the functionality of the communication channel 120 may also be embodied in the local communications network 222.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g. CD-ROM, DVD, Blu-ray Disc™), USB-RAM, portable, external hard drives, and floppy disks, for example, may be used as appropriate sources of data to the computer system 200. Typically, any of the HDD 210, optical drive 212, networks 220 and 222 may also be configured to operate as the HDR imaging sensor 112, or as a destination for decoded video data to be stored for reproduction via the display 214. The capture device 110 and the display device 160 of the system 100 may be embodied in the computer system 200.

The components 205 to 213 of the computer module 201 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun SPARC stations, Apple Mac™ or alike computer systems.

Where appropriate or desired, the video encoder 118 and the video decoder 162, as well as methods described below, may be implemented using the computer system 200 wherein the video encoder 118, the video decoder 162 and methods to be described, may be implemented as one or more software application programs 233 executable within the computer system 200. In particular, the video encoder 118, the video decoder 162 and the steps of the described methods are effected by instructions 231 (see FIG. 2B) in the software 233 that are carried out within the computer system 200. The software instructions 231 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous apparatus for implementing the video encoder 118, the video decoder 162 and the described methods.

The software 233 is typically stored in the HDD 210 or the memory 206. The software is loaded into the computer system 200 from a computer readable medium, and executed by the computer system 200. Thus, for example, the software 233 may be stored on an optically readable disk storage medium (e.g., CD-ROM) 225 that is read by the optical disk drive 212.

In some instances, the application programs 233 may be supplied to the user encoded on one or more CD-ROMs 225 and read via the corresponding drive 212, or alternatively may be read by the user from the networks 220 or 222. Still further, the software can also be loaded into the computer system 200 from other computer readable media. Computer readable storage media refers to any non-transitory tangible storage medium that provides recorded instructions and/or data to the computer system 200 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of the software, application programs, instructions and/or video data or encoded video data to the computer module 201 include radio or infra-red transmission channels as well as a network connection to another computer or networked device, and the Internet or Intranets including e-mail transmissions and information recorded on Websites and the like.

The second part of the application programs 233 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

FIG. 2B is a detailed schematic block diagram of the processor 205 and a “memory” 234. The memory 234 represents a logical aggregation of all the memory modules (including the HDD 209 and semiconductor memory 206) that can be accessed by the computer module 201 in FIG. 2A.

When the computer module 201 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 201 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high level functions, including processor management, memory management, device management, storage management, software application interface, and generic user interface.

The operating system 253 manages the memory 234 (209, 206) to ensure that each process or application running on the computer module 201 has sufficient memory in which to execute without colliding with memory allocated to another process. Furthermore, the different types of memory available in the computer system 200 of FIG. 2A must be used properly so that each process can run effectively. Accordingly, the aggregated memory 234 is not intended to illustrate how particular segments of memory are allocated (unless otherwise stated), but rather to provide a general view of the memory accessible by the computer system 200 and how such is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The video encoder 118, the video decoder 162 and the described methods may use input variables 254, which are stored in the memory 234 in corresponding memory locations 255, 256, 257. The video encoder 118, the video decoder 142 and the described methods produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:

(a) a fetch operation, which fetches or reads an instruction 231 from a memory location 228, 229, 230;

(b) a decode operation in which the control unit 239 determines which instruction has been fetched; and

(c) an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

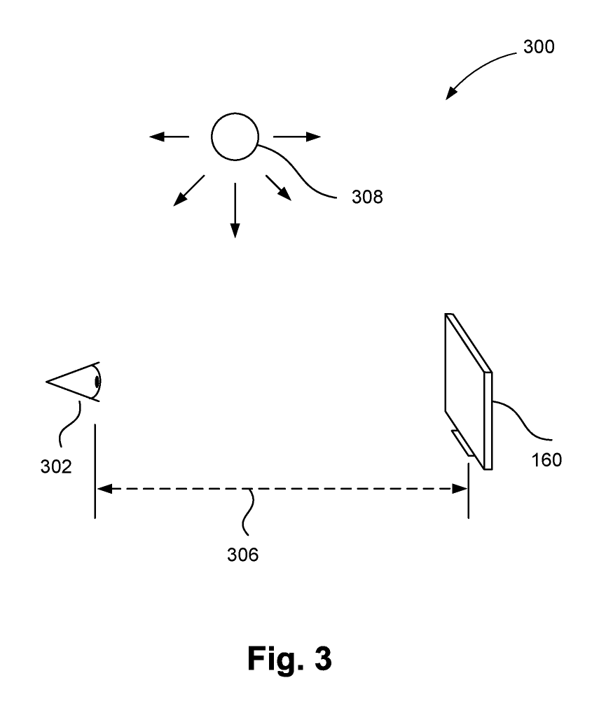

FIG. 3 schematically illustrates an exemplary environment for the display device 160. A viewing environment 300 has one or more human observers, e.g. a human observer 302, the display device 160 and ambient illumination 308. The human observer 302 is separated from the display device 160 by a viewing distance 306. The intensity of light subjected to the human observer 302 is a weighted function of the ambient illumination 308 and the light level emitted from the display device 160, attenuated by the viewing distance 306. The HVS in the human observer 302 adapts to the light intensity emitted from the display device 160 and the ambient illumination 308. The viewing environment may also be the mastering environment within which the human operator performs colour grading. In both situations, adaptation of the HVS is also dependent on the ambient illumination. For a fully-adapted HVS, and for a given light level, a minimum change (or ‘delta’) in terms of luminance exists, below which there is no variation in brightness perceived by the human observer 302. This threshold is known as a ‘just noticeable difference’ (JND) threshold.

A number of models for the contrast sensitivity of the HVS, based upon experimental data from various sources, were developed by Peter Barten. In particular, the physical model (hereinafter referred to as the ‘Buten model’) is reproduced as follows:

$$S ( u ) = \frac{1}{{m}_{t}} = \frac{{M}_{opt} ( u ) / k}{\sqrt{\frac{2}{T} ( \frac{1}{{X}_{0}^{2}} + \frac{1}{{X}_{ma x}^{2}} + \frac{{u}^{2}}{{N}_{ma x}^{2}} ) ( \frac{1}{ηρ E} + \frac{{Φ}_{0}}{1 - {e}^{- {( u / {u}_{0} )}^{2}}} )}} \qquad ( Eqn . 1 )$$

where S(u) is the sensitivity function; u is the spatial frequency in cycles per degree; mₜ is the inverse of sensitivity, which is the modulation threshold; Mₒₚₜ(u) is the optical modulation transfer function (MTF) of the eye; k is the signal to noise ratio; T is the integration time of the eye; X₀ is the angular size of the object; Xₘₐₓ is the maximum angular size of the integration area of the noise; Nₘₐₓ is the maximum number of cycles over which the eye can integrate the information; η is the quantum efficiency of the eye; E is the retinal illuminance in Troland; ρ is the photon conversion factor, in photons per second per square degree per Troland; Φ₀ is the spectral density of the neural noise; and u₀ is the spatial frequency above which the lateral inhibition ceases.

The Barten model of Eqn. 1 is also known as the contrast sensitivity function (CSF), or the ‘Barten CSF’.

The retinal illuminance E and the optical MTF Mₒₚₜ(u) are additionally functions of the object luminance L. Thus, a single object luminance corresponds to a contrast sensitivity curve. By taking the maximum sensitivity for each curve corresponding to a range of object luminances, it is possible to construct a sensitivity function over object luminances S(L). Then, the inverse of the sensitivity function yields modulation thresholds predicted by the Barten model, which may be used to directly derive JND thresholds for a given object luminance.

FIG. 4A contains a graph 400 showing the relationship between absolute luminance and the corresponding contrast step, for various transfer functions encoding at a particular bit depth. The graph 400 shows absolute luminance on a log scale on the X axis and the minimum contrast step as a percentage, also on a log scale on the Y axis. A Barten curve 402 shows the minimum contrast step for a given absolute luminance to produce a visible difference in brightness (i.e. a JND step). The Barten curve 402 covers a wide range of luminances (the graph 400 depicts luminances ranging from 10⁻³ to 10⁴ nits). The Barten model from which the Barten curve 402 is derived assumes full adaptation, i.e. a viewer would not be subject to stimulus corresponding to rapid transitions horizontally along the graph 400. The ITU-R BT.1886 transfer function is an EOTF designed to model the behaviour of standard dynamic range cathode ray tube (CRT) systems. To extend the ITU-R BT.1886 transfer function to high dynamic range luminances, it may be stretched to a range of up to 10³ nits, and quantised with 10 bit precision, resulting in a contrast step function 404. At low luminances, the contrast step function 404 results in steps that are substantially larger than the JND steps implied by the Barten curve 402. Thus, ITU-R BT.1886 is unsuitable for an HDR system supporting up to 10³ nits, even with 10 bit precision. The PQ-EOTF supports up to 10⁴ nits and may be quantised to various bit depths. A contrast step function 406 shows the resulting step sizes when the PQ-EOTF is quantised to 10 bits. The contrast step function 406 is above the Barten curve 404, implying that the provided step sizes exceed the JND threshold of a fully adapted human eye. In practice, the degree by which the contrast step function 406 exceeds the JND threshold is small, and experiments could not produce visible banding artefacts. One reason is that the JND threshold associated with the Barten curve 404 are measured using a static, simple, image, with a fully-adapted human eye. For moving images with various objects and textures, and a wide variety of luminances simultaneously displayed by the display device 160, higher JND thresholds can be expected in practice.

FIG. 4B contains a graph 440 showing the perceptual-quantiser (PQ) electro-optical transfer function 442 (EOTF), with 10-bit quantisation. The PQ-EOTF 442 is designed to closely fit a curve resulting from iterative addition of multiples of just noticeable differences (f*JND) derived from the Barten model. The PQ-EOTF 442 differs from the Barten model in that the lowest codeword corresponds to a luminance of 0 nits, asymptotically not depicted in FIG. 4B. The graph 400 shows the codeword values along the X axis, with quantisation to 10 bits, and absolute luminance on the Y axis over the range supported by the PQ-EOTF 442. The range of available codewords intended for use is restricted to 64 to 940, known as ‘video range’. This accords with common practice for video systems operating at a bit depth of 10 bits (other transfer functions may permit excursions outside this range in some cases). The codeword range from 64 to 940 corresponds to luminances from 0 nits (not shown on the graph) to 10⁴ nits. Adjacent codewords correspond to steps above the JND threshold for a fully-adapted human eye, as discussed with reference to FIG. 4A.

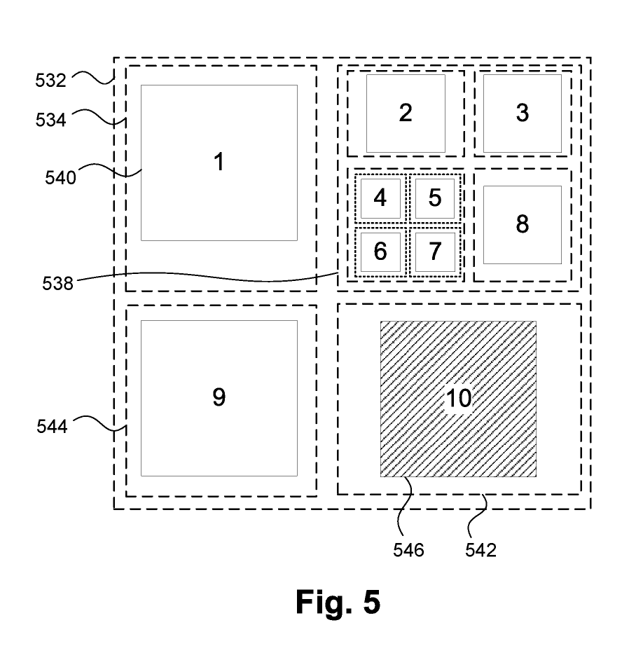

FIG. 5 shows a decomposition of a coding tree unit (CTU) 532 into several coding units (CUs) and transform units (TUs). Each frame of the video data is divided into a two-dimensional array of CTUs. Each CTU is generally 64×64 luma samples in size, although other sizes, such as 32×32 and 16×16, are also possible. Each CTU includes a hierarchical decomposition into one or more coding units (CUs), according to a recursive quad-tree. For example, the CTU 532 is split into four CUs 534, 538, 544 and 542, each of size 32×32 luma samples in this example. Each CU includes a ‘residual quad-tree’ (RQT) that provides an additional quad-tree subdivision of the CU into zero or more TUs. For example, the CU 534 includes one TU 540 (numbered 1). The presence of a transform block (TB) in each colour channel of a given TU at each leaf node of the RQT is signalled using a ‘coded block flag’. When the coded block flag is zero, no TB is present. This indicates that each coefficient associated with the TB for the considered colour channel of the TU has a value of zero, and as such, the transform associated with the TB is not required to be performed. For example, the CU 542 includes a 32×32 TU 546 (numbered 10) but no TB is performed (this example considers the luma channel only). The 32×32 CU 538 includes a RQT decomposition into four 16×16 blocks, one of which is further decomposed into four 8×8 blocks. This RQT decomposition results in three 16×16 TUs (numbered 2, 3 and 8) and four 8×8 TUs (numbered 4, 5, 6 and 7) being contained in the 32×32 CU 538. The CU 544 has a single TU (numbered 9). An array of residual coefficients is associated with each TB. The residual coefficients code the values as processed by the transform according to the ‘quantisation parameter’ (QP). For a given TU, if at least one TB is coded (i.e. in any colour channel) then a ‘delta QP’ may also be present in the bitstream, and represents a change in the quantisation parameter from a previous TU. In this regard it is more efficient to encode a delta value rather than an absolute value. The delta QP allows for local adjustment of the QP applied to the current (and subsequent) TBs. Adjusting the QP alters step size when converting a residual coefficient into a transform coefficient (i.e. a coefficient passed to the transform). When performing the transform, this results in a corresponding adjustment of the step size of the residual samples of the TB (i.e. in the spatial domain) that accords with the basis function of the considered residual coefficient. Thus, the step size in codewords in the spatial domain is influenced by the QP of residual coefficients in the frequency domain.

Generally, the transfer function used by the video processing system 100 is formed with luminance steps dependent on response of the human visual system to a single object luminance, with the surround luminance fixed at an assumed level. For example, the PQ-EOTF 442 is based on contrast sensitivity functions derived from the Barten model, which assumes full adaptation to a single object luminance. The HLG-OETF is based on backwards compatibility with the standard dynamic range OETF, ITU-R Recommendation BT.709, which assumes standard TV viewing conditions. However, for regions with relatively low magnitude luminances, the human observer 302 may be adapted to a brighter environment, due to ambient conditions (e.g. 308), or due to brighter, neighbouring portions of the video data. The adaptation to a brighter environment due to ambient conditions or neighbouring portions may result in larger JNDs for the human observer than would be assumed by the transfer function. Thus, in regions with relatively low magnitude luminances, the QP may be increased without affecting the subjective quality of the final video data output by the display device 160. The video encoder 118 exploits this to achieve overall bit rate reduction, or alternatively reduce the overall QP applied to the entire frame, resulting in an overall improvement in subjective quality. Such local adjustment of QP is achieved in the video encoder 118 using the delta QP mechanism.

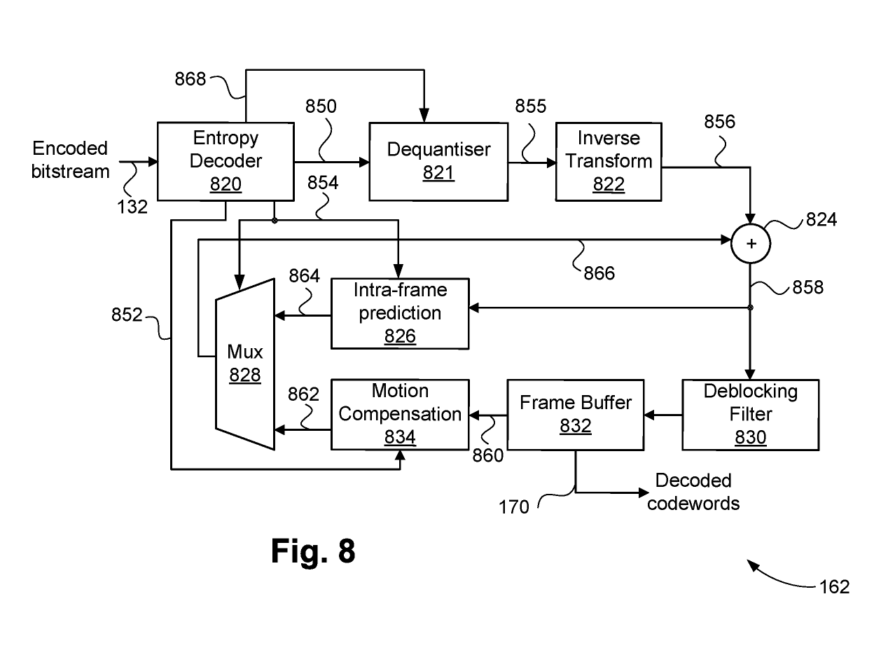

FIG. 6 is a schematic block diagram showing functional modules of the video encoder 118. FIG. 8 is a schematic block diagram showing functional modules of the video decoder 162. Generally, data is passed between functional modules within the video encoder 118 and the video decoder 162 in blocks or arrays (e.g., blocks of samples or blocks of transform coefficients). Where a functional module is described with reference to the behaviour of individual array elements (e.g., samples or a transform coefficient), the behaviour shall be understood to be applied to all array elements. The video encoder 118 and video decoder 162 may be implemented using a general-purpose computer system 200, as shown in FIGS. 2A and 2B, where the various functional modules may be implemented by dedicated hardware within the computer system 200, by software executable within the computer system 200 such as one or more software code modules of the software application program 233 resident on the hard disk drive 205 and being controlled in its execution by the processor 205, or alternatively by a combination of dedicated hardware and software executable within the computer system 200. The video encoder 118, the video decoder 162 and the described methods may alternatively be implemented in dedicated hardware, such as one or more integrated circuits performing the functions or sub functions of the described methods. Such dedicated hardware may include graphic processors, digital signal processors, application specific integrated circuits (ASICs), field programmable gate arrays (FPGAs) or one or more microprocessors and associated memories. In particular the video encoder 118 comprises modules 620-646 and the video decoder 162 comprises modules 820-834 which may each be implemented as one or more software code modules of the software application program 233.

Although the video encoder 118 of FIG. 6 is an example of a high efficiency video coding (HEVC) video encoding pipeline, other video codecs may also be used to perform the processing stages described herein. The video encoder 118 receives captured frame data 130, such as a series of frames, each frame including one or more colour channels.

The video encoder 118 divides each frame of the captured frame data, such as frame data 130, into CTUs. The video encoder 118 produces one or more arrays of data samples, generally referred to as ‘prediction units’ (PUs) for each coding unit (CU) associated with the considered CTU. Various arrangements of prediction units (PUs) in each coding unit (CU) are possible, with a requirement that the prediction units (PUs) do not overlap and that the entirety of the coding unit (CU) is occupied by the one or more prediction units (PUs). Such a requirement ensures that the prediction units (PUs) cover the entire frame area.

The video encoder 118 operates by outputting, from a multiplexer module 640, a prediction unit (PU) 682. A difference module 644 produces a ‘residual sample array’ 660. The residual sample array 660 is the difference between the prediction unit (PU) 682 and a corresponding 2D array of data samples from a coding unit (CU) of the coding tree block (CTB) of the frame data 130. The difference is calculated for corresponding samples at each location in the arrays. As differences may be positive or negative, the dynamic range of one difference sample is the bit-depth of the frame data 130 plus one bit.

The residual sample array 660 may be transformed into the frequency domain in a transform module 620. The residual sample array 660 from the difference module 644 is received by the transform module 620, which converts the residual sample array 660 from a spatial representation to a frequency domain representation by applying a ‘forward transform’.

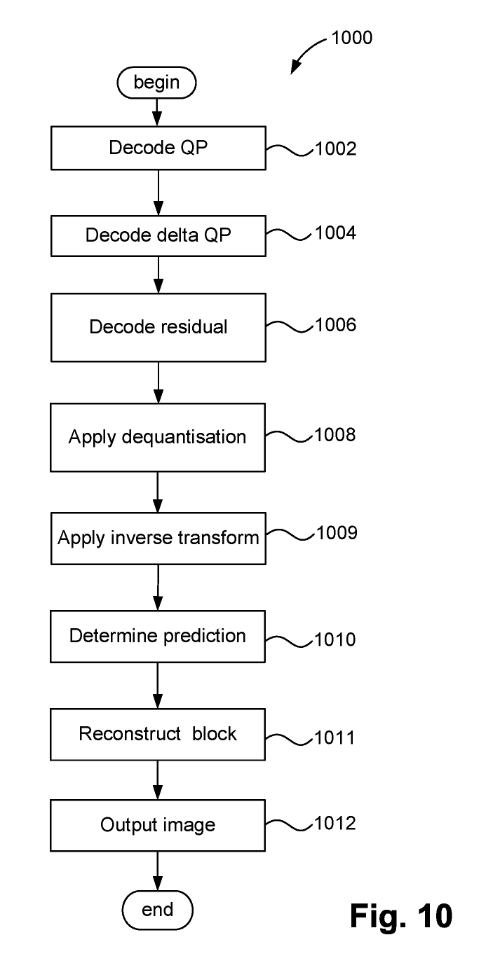

A quantiser control module 646 may be used to test the bit-rate resulting in the encoded bitstream 312 using various possible quantisation parameter values according to a ‘rate-distortion criterion’ to achieve the target bit rate. The quantiser control module 646 receives the luminance measure 136 from the luminance measurer 116 and determines an adjustment (if needed) to the quantisation parameter as described with reference to FIG. 10 below. The rate-distortion criterion is a measure of the acceptable trade-off between the bit-rate of the encoded bitstream 130, or a local region thereof, and distortion. Distortion is a measure of the difference between frames present in the frame buffer 632 and the captured frame data 130. Distortion may be determined using a peak signal to noise ratio (PSNR) or sum of absolute differences (SAD) metric. The PSNR and SAD metrics measure the error in terms of difference between codeword values between a reference (e.g. input video data) and a test block (e.g. reconstructed samples) of video data. As such, differences in the subjective significance of errors for different absolute magnitudes of codewords in the input video data and the reconstructed samples are not taken into account. The rate-distortion criterion corresponds to a predetermined ‘lambda’ parameter, available to all modules in the video encoder 118 that select different modes (e.g. prediction modes) to be encoded into the encoded bitstream 132. The lambda parameter may be a fixed value configured in the memory 206 for use by modules involved in making encoder ‘decisions’, i.e. mode choices, such as the quantiser control module 646.

A quantisation parameter 684 is output from the quantiser control module 646. The quantisation parameter varies on a block by block basis as the frame is being encoded.

For the HEVC standard, conversion of the residual sample array 660 to the frequency domain representation is implemented by the transform module 620 using a transform such as a modified discrete cosine transform (DCT). In such transforms, the modification permits implementation using shifts and additions instead of multiplications. Such modifications enable reduced implementation complexity compared to a discrete cosine transform (DCT). In addition to the modified discrete cosine transform (DCT), a modified discrete sine transform (DST) may also be used in specific circumstances. The transform module 620 outputs scaled transform coefficients 662. Various sizes of the residual sample array 660 and the scaled transform coefficients 662 are possible, in accordance with supported transform sizes implemented by the transform module 620. In accordance with the terminology of the HEVC standard (applied to the video encoder 118), the scaled transform coefficients 662 refer to transform coefficients that have not yet been adapted (i.e. compressed) according to the quantisation parameter 684. As such, the scaled transform coefficients 662 are produced by the transform module 620. In the HEVC standard, transforms are performed on 2D arrays of data samples having sizes of 32×32, 16×16, 8×8 or 4×4.

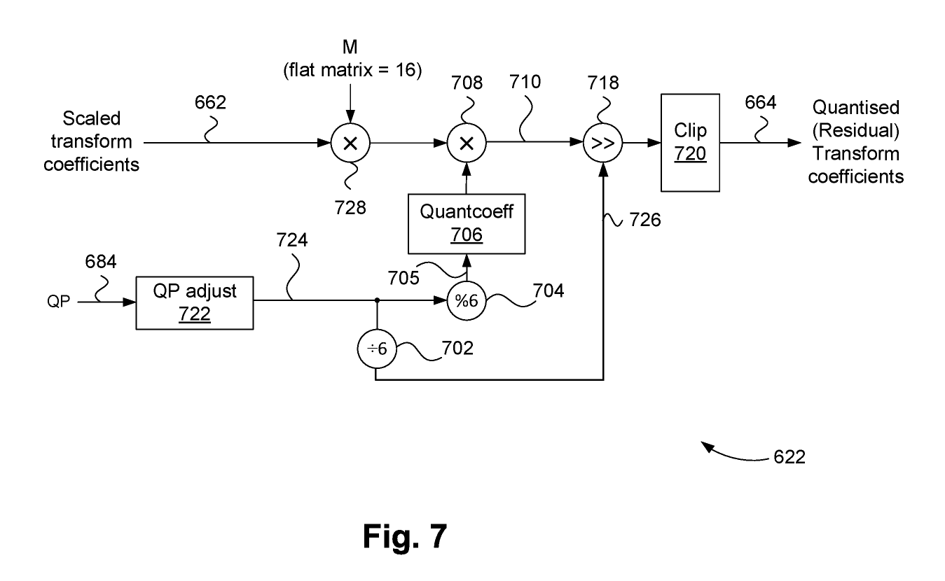

The scaled transform coefficients 662 are input to a quantiser module 622 where data sample values thereof are scaled and quantised, according to a determined quantisation parameter 684, to produce quantised transform (or residual) coefficients 664. The quantiser module 622 is discussed further with reference to FIG. 7. The quantised transform coefficients 664 are an array of values having the same dimensions as the residual sample array 660. The quantised transform coefficients 664 provide a frequency domain representation of the residual sample array 660. The scale and quantisation results in a loss of precision, dependent on the value of the determined quantisation parameter 684. A higher value of the determined quantisation parameter 684 results in greater information being lost from the residual (quantised) data. The loss of information increases the compression achieved by the video encoder 118, as the reduced magnitude of the residual coefficients require fewer bits to encode. This increase in compression efficiency occurs at the expense of reducing the visual quality of output from the video decoder 162.

The quantised transform coefficients 664 and determined quantisation parameter 684 are taken as input to the dequantiser module 626. The dequantiser module 626 reverses the scaling performed by the quantiser module 622 to produce rescaled transform coefficients 666. The rescaled transform coefficients 666 are rescaled versions of the quantised transform coefficients 664. The quantised transform coefficients 664 and the determined quantisation parameter 684 are also taken as input to an entropy encoder module 624. The entropy encoder module 624 encodes the values of the quantised transform coefficients 664 in an encoded bitstream 130 (or ‘video bitstream’). Due to the loss of precision resulting from the operation of the quantiser module 622, the rescaled transform coefficients 666 are not identical to the original values in the scaled transform coefficients 662. The rescaled transform coefficients 666 from the dequantiser module 626 are then output to an inverse transform module 628. The inverse transform module 628 performs an inverse transform from the frequency domain to the spatial domain to produce a spatial-domain representation 668 of the rescaled transform coefficients 666. The spatial-domain representation 668 is substantially identical to a spatial domain representation that is produced at the video decoder 162. The spatial-domain representation 668 is then input to a summation module 642.

A motion estimation module 638 produces motion vectors 674 by comparing the frame data 130 with previous frame data 633 from one or more sets of frames stored in a frame buffer module 632, generally configured within the memory 206. The sets of frames are known as ‘reference picture lists’. The motion vectors 674 are then input to a motion compensation module 634 which produces an inter-predicted prediction unit (PU) 676 by filtering data samples stored in the frame buffer module 632, taking into account a spatial offset derived from the motion vectors 674. Not illustrated in FIG. 6, the motion vectors 674 are also passed as syntax elements to the entropy encoder module 624 for encoding in the encoded bitstream 132. An intra-frame prediction module 636 produces an intra-predicted prediction unit (PU) 678 using samples 670 obtained from the summation module 642. The intra-frame prediction module 636 also produces an intra-prediction mode 680 which is sent to the entropy encoder 624 for encoding into the encoded bitstream 132.

Prediction units (PUs) may be generated using either an intra-prediction or an inter-prediction method. Intra-prediction methods make use of data samples adjacent to the prediction unit (PU) that have previously been decoded (typically above and to the left of the prediction unit) in order to generate reference data samples within the prediction unit (PU). Various directions of intra-prediction are possible, referred to as the ‘intra-prediction mode’. Inter-prediction methods make use of a motion vector to refer to a block from a selected reference frame. The motion estimation module 638 and motion compensation module 634 operate on motion vectors 674, having a precision of one quarter (¼) of a luma sample, enabling precise modelling of motion between frames in the frame data 132. The decision on which of the intra-prediction or the inter-prediction method to use is made according to a rate-distortion trade-off. The trade-off is made between the desired bit-rate of the resulting encoded bitstream 132 and the amount of image quality distortion introduced by either the intra-prediction or inter-prediction method. The trade-off is input to the multiplexer 640 by a signal 686 which is determined by a prediction mode selection module (not shown in FIG. 6) that uses the lambda parameter to assist in selecting an optimal mode according to a bit rate versus distortion trade-off. If intra-prediction is used, one intra-prediction mode is selected from the set of possible intra-prediction modes, also according to a rate-distortion trade-off. The multiplexer module 640 may select either the intra-predicted reference samples 678 from the intra-frame prediction module 636, or the inter-predicted prediction unit (PU) 676 from the motion compensation block 634.

The summation module 642 produces a sum 670 that is input to a de-blocking filter module 630. The de-blocking filter module 630 performs filtering along block boundaries, producing de-blocked samples 672 that are written to the frame buffer module 632 configured within the memory 206. The frame buffer module 632 is a buffer with sufficient capacity to hold data from one or more past frames for future reference as part of a reference picture list.

For the high efficiency video coding (HEVC) standard, the encoded bitstream 132 produced by the entropy encoder 624 is delineated into network abstraction layer (NAL) units. Generally, each slice of a frame is contained in one NAL unit. The entropy encoder 624 encodes the quantised transform coefficients 664, the intra-prediction mode 680, the motion vectors and other parameters, collectively referred to as ‘syntax elements’, into the encoded bitstream 132 by performing a context adaptive binary arithmetic coding (CABAC) algorithm. Syntax elements are grouped together into ‘syntax structures’. The groupings may contain recursion to describe hierarchical structures. In addition to ordinal values, such as an intra-prediction mode or integer values, such as a motion vector, syntax elements also include flags, such as to indicate a quad-tree split.

FIG. 7 is a schematic block diagram showing functional modules of the quantiser module 622. The quantiser module 622 is configured to reduce the magnitude of (or ‘quantise’) the scaled transform coefficients 662 to produce the quantised transform coefficients 664 according to the quantisation parameter QP 684. Larger quantisation parameter values result in smaller magnitudes for the quantised transform coefficients 664.

The quantiser module 622 behaves such that each increase of the quantisation parameter 684 by six results in a halving of the magnitude of the quantised transform coefficients 664. The quantisation parameter 684 is input to a QP adjust module 722 which adjusts the quantisation parameter 684 according to the bit depth to produce a QP-prime 724. The QP-prime 724 is equal to the quantisation parameter 684 plus six times the result of bit-depth minus 8 (i.e. QP-prime=QP+6*(bit depth−8)). The quantiser module 622 may be considered to apply a (QP-dependent) gain to the scaled transform coefficients 662.

The transform module 620 and the quantiser module 622 have the following behaviour at QP-prime of four: If the nT×nT sized residual sample array 660 consists of a DC value having value ‘x’, the DC coefficient of the quantised transform coefficients 664 will be equal to nT*x. Quantisation accords with a geometric progression such that every six QP-prime increments results in a halving of the magnitude of the quantised transform coefficients 664, with intermediate QP-prime values scaled accordingly. A modulo 6 module 704 determines the modulo 6 of the QP-prime 724, producing a QP-prime remainder value 705. The QP-prime remainder value 705, from zero (0) to five (5), is passed to a Quantcoeff module 706. The Quantcoeff module 706 contains an array of values that approximates a decreasing geometric progression. For example, the array of values may be [26214, 23302, 20560, 18396, 16384, 14564]. The QP-prime remainder 705 is used to select from the array of values. For example, a QP-prime remainder 705 of zero would select the value 26214. Bit shift offsets provided to a right shift module compensate for the magnitudes of the values in the Quantcoeff table by providing a right shift offset of 14 (in addition to other factors influencing the shift amount). Accordingly, a multiplication by 16384 cancels out to produce a gain of 1.0. Overall, the Quantcoeff module 706 provides predetermined gains in the range of 0.89 to 1.60, selected according to the QP-prime remainder 705 and providing six discrete gains within each power-of-two step size increase that results from QP_per. To achieve high accuracy and due to the integer implementation of the quantiser module 622, a large positive gain exists in the array of values provided by the Quantcoeff module 706. By normalising the array of values provided by the Quantcoeff module 706 to the QP-prime remainder value 705 of four, the gain of the array of values is 16384, or two to the power of fourteen (14).

The gain due to multiplication by a value from the Quantcoeff module 706 represents effectively a left shift of fourteen bits. For QP-prime remainder values 705 from zero to three, the gain of the array of values provided by the Quantcoeff module 706 is larger than 16384 (but less than 32768) so effectively, an additional one bit of gain exists when the QP-prime remainder values are used.

The output of the Quantcoeff module 706 is passed to a multiplier module 708 to produce a product 710. The multiplier module 708 applies the selected Quantcoeff value from the array of values to each coefficient of the scaled transform coefficients 662. As the scaled transform coefficients 662 have MAX_TR_DYNAMIC_RANGE bits width (plus one sign bit) and the Quantcoeff module 706 output has fifteen (15) bits output width, the product 710 has a width of MAX_TR_DYNAMIC_RANGE plus sixteen (16) bits.

The product 710 is passed to the right shift module 718. The right shift module 718 performs a right shift according to a right shift amount 726. The right shift amount 726 is derived from a divider module 702.

The divider module 702 produces a quotient (or ‘QP period’) by performing an integer division of QP-prime 724 by six to produce the right shift amount 726. In this situation, the quantiser module 622 behaves such that the DC coefficient of the scaled transform coefficients 662 is equal to the DC value ‘x’ of the residual sample array 660 multiplied by the size of the transform nT when QP-prime 724 is equal to four.

The output of the right shift module 718 is desirably passed through a clip module 720. The clip module 720 may apply a clip according to plus/minus two to the power of an ENTROPY_CODING_DYNAMIC_RANGE constant.

The ENTROPY_CODING_DYNAMIC_RANGE constant defines the range of the quantised transform coefficients 664 and thus the range of values to be encoded in the encoded bitstream 132. For an HEVC Main profile or HEVC Main10 profile encoder or decoder, the ENTROPY_CODING_DYNAMIC_RANGE is equal to the MAX_TR_DYNAMIC_RANGE value of 15.

In a further desirable implementation, specifically as illustrated in FIG. 7, the scaled transform coefficients 662 may be modified prior to input to the multiplier module 708. In such an implementation, the scaled transform coefficients 662 may be input to a further multiplier module 728 whereupon the coefficients are multiplied by an integer scale factor matrix M having a size corresponding to the TB which, for example, may be a flat matrix where each matrix element has a value of 16. This operates to further scale the coefficients 622 to provide a quantisation step size below the threshold of a single QP increment. With this approach, adjustment of the quantisation parameter (QP) 684, via the Quantcoeff 706 results on adjusting one or more quantisation matrices to achieve a similar desired effect, but with finer granularity.

The purpose of the quantiser module 622 is to compress the scaled transform coefficients 662 by down-scaling the scaled transform coefficients 662 to values of reduced magnitude, and in the process discarding the least significant data, i.e. remainder of the divisions inherent in the down-scaling process. The gain of the quantiser module 622 is thus normally less than or equal to unity (i.e. one), as the quantiser module 622 is intended to compress (i.e. downscale) the scaled transform coefficients 662 to produce the quantised transform coefficients 664, each of which represent codewords in the frequency domain. For example, if one of the scaled transform coefficients 662 has a value of 100 and the quantisation step size is 5 then the corresponding quantised transform coefficient will have a value of 20. As can be seen, the gain of the quantiser module 622 is the reciprocal of the quantisation step size, i.e. 0.2 in this case. Then, for different magnitudes of quantised residual coefficients, an increment (or decrement) of the coefficient corresponds to a change in luminance that accords with the PQ EOTF 422. Moreover, the change is not constant in terms of the perceived luminance (i.e. is not a multiple if a JND). For portions of the frame having a lower representative luminance, further increases of the quantisation parameter are possible, restoring the change in terms of JND step size (i.e. to a desired JND step size) to a level that accords with other portions of the frame having a higher representative luminance.

Although the video decoder 162 of FIG. 8 is described with reference to a high efficiency video coding (HEVC) video decoding pipeline, other video codecs may also employ the processing stages of modules 820-834. As seen in FIG. 8, received video data, such as the encoded bitstream 132, is input to the video decoder 162. The encoded bitstream 132 may be read from memory 206, the hard disk drive 210, a CD-ROM, a Blu-ray™ disk or other computer readable storage medium. Alternatively the encoded bitstream 132 may be received from an external source such as a server connected to the communications network 220 or a radio-frequency receiver. The encoded bitstream 132 contains encoded syntax elements representing the captured frame data to be decoded.

The encoded bitstream 132 is input to an entropy decoder module 820 which extracts the syntax elements from the encoded bitstream 132 and passes the values of the syntax elements to other blocks in the video decoder 162. The entropy decoder module 820 applies the context adaptive binary arithmetic coding (CABAC) algorithm to decode syntax elements from the encoded bitstream 132. The decoded syntax elements are used to reconstruct parameters within the video decoder 162. Parameters include zero or more residual data array 850, motion vectors 852, a prediction mode 854, and a quantisation parameter 868. The quantisation parameter 868 was encoded in the encoded bitstream 132 by the video encoder 118 according to the quantisation parameter 684, and is reconstructed by applying delta QPs as may be present in the encoded bitstream 132 to provide local adjustment of the QP. The residual data array 850 is passed to a dequantiser module 821, the motion vectors 852 are passed to a motion compensation module 834, and the prediction mode 854 is passed to each of an intra-frame prediction module 826 and to a multiplexer 828.

The dequantiser module 821 performs inverse scaling on the residual data of the residual data array 850 to create reconstructed data 855 in the form of transform coefficients. The dequantiser module 821 outputs the reconstructed data 855 to an inverse transform module 822. The inverse transform module 822 applies an ‘inverse transform’ to convert the reconstructed data 855 (i.e., the transform coefficients) from a frequency domain representation to a spatial domain representation, outputting a residual sample array 856. The inverse transform module 822 performs the same operation as the inverse transform module 628. The inverse transform module 822 is configured to perform inverse transforms sized in accordance with the transform size used in the encoder 118 having a bit-depth according to the bit-depth. The transforms performed by the inverse transform module 822 are selected from a predetermined set of transform sizes required to decode an encoded bitstream 132 that is compliant with the high efficiency video coding (HEVC) standard.

The motion compensation module 834 uses the motion vectors 852 from the entropy decoder module 820, combined with reference frame data 860 from a frame buffer block 832, configured within the memory 206, to produce an inter-predicted prediction unit (PU) 862 for a prediction unit (PU). The inter-prediction prediction unit (PU) 862 is a prediction of output decoded frame data based upon previously decoded frame data. When the prediction mode 854 indicates that the current prediction unit (PU) was coded using intra-prediction, the intra-frame prediction module 826 produces an intra-predicted prediction unit (PU) 864 for the prediction unit (PU). The intra-prediction prediction unit (PU) 864 is produced using data samples spatially neighbouring the prediction unit (PU) and a prediction direction also supplied by the prediction mode 854. The spatially neighbouring data samples are obtained from a sum 858, output from a summation module 824. The multiplexer module 828 selects the intra-predicted prediction unit (PU) 864 or the inter-predicted prediction unit (PU) 862 for a prediction unit (PU) 866, depending on the current prediction mode 854. The prediction unit (PU) 866, which is output from the multiplexer module 828, is added to the residual sample array 856 from the inverse scale and transform module 822 by the summation module 824 to produce the sum 858. The sum 858 is then input to each of a de-blocking filter module 830 and the intra-frame prediction module 826. The de-blocking filter module 830 performs filtering along data block boundaries, such as transform unit (TU) boundaries, to smooth visible artefacts. The output of the de-blocking filter module 830 is written to the frame buffer module 832 configured within the memory 206. The frame buffer module 832 provides sufficient storage to hold one or more decoded frames for future reference. Decoded codewords 170 are also output from the frame buffer module 832 to a display device, such as the display device 162 (e.g., in the form of the display device 214).

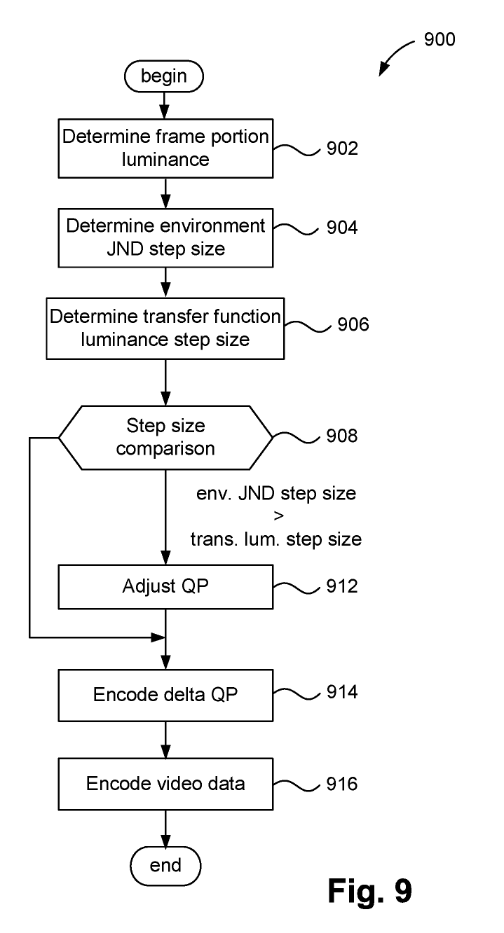

FIG. 9 is a schematic flow diagram showing a method 900 of encoding a portion (e.g. a CTU) of a frame, performed in the video encoder 118. The method 900 provides for local QP adjustment when encoding each frame using the ‘delta QP’ syntax element. Local QP adjustment can occur within CTUs, CUs and TUs for a frame and is dependent on a local luminance measure and reduces bit rate in portions of the frame where a reduction in quality will be less (or not at all) subjectively significant. The method 900 may be implemented as part of the video encoder 118, which may, for example, be implemented as hardware (e.g., in an ASIC or an FPGA) or software. The method 900 will be described by way of example where the method 900 is implemented as one or more code modules of the software application program 233 resident with the hard disk drive 210 and being controlled in its execution by the processor 205.

The method 900 begins with a determine frame portion luminance step 902.

At the determine frame portion luminance step 902, the luminance measurer 116, under control of the processor 205, determines the representative (typically average) luminance of the samples in a portion, e.g. a CTU, of the frame data 130. With codeword input to the video encoder 118, applying the inverse of the PQ-EOTF 442 of FIG. 4B enables the absolute luminance of each sample to be obtained. Then an averaging process of all samples in the portion is performed, resulting in an accurate measure of the local luminance of the portion. For reduced-complexity implementations, the codewords can be directly averaged, followed by application of the inverse PQ-EOTF 442. Such reduced-complexity implementations produce a final average that differs from the true average due to the averaging of codeword values, which express luminance in a non-linear domain. However, such reduced-complexity implementations avoid performing the inverse PQ-EOTF 442 operation separately on each sample within the portion of the frame data. Control in the processor 205 of the method 900 then passes to a determine environment JND step size step 904.

At the determine environment JND step size step 904, the processor 205 is used to determine the JND step size (e.g. as a luminance measure) using the average luminance resulting from the determine frame portion luminance step 902 and the ambient luminance, e.g. as available from the ambient light sensor 114. In one arrangement, the Barten model S(L) derived from Equation 1 may be modified by multiplying it by a correction factor f

$$f = {e}^{- \frac{l {n}^{2} ( \frac{{L}_{S}}{L} {( 1 + \frac{144}{{X}_{0}^{2}} )}^{0.25} ) - l {n}^{2} ( {( 1 + \frac{144}{{X}_{0}^{2}} )}^{0.25} )}{2 l {n}^{2} ( 32 )}} \qquad ( Eqn . 2 )$$

where X₀ is the angular size of the object, as in Eqn. 1; L is average luminance resulting from the determine frame portion luminance step 902; and Lₛ is the ambient luminance.

The modified Barten model may then be used to calculate modified JND step sizes at each luminance as follows:

$$JND ( L ) = 2 * \frac{1}{f * S ( L )} * L \qquad ( Eqn . 3 )$$

The calculation of modified JND step sizes using the modified Barten model (Eqn. 3 above) is motivated by an interpretation of the definition of the modulation threshold as

$${m}_{t} = \frac{{L}_{ma x} - {L}_{m i n}}{{L}_{ma x} + {L}_{m i n}} ,$$

where Lₘₐₓ and Lₘᵢₙ are the upper and lower luminances of a sinusoidal luminance intensity pattern. The interpretation related to Eqn. 3 is different from the interpretation used for the determination of luminance step sizes for the PQ-EOTF transfer function. One advantage of the present interpretation is that small values of the modified sensitivity

$$( \frac{1}{f * S ( L )} )$$

result in modified JND step sizes that smoothly increase, while for other interpretations the calculation may result in modified JND step sizes that are infinite, or negative. For large values of the modified sensitivity

$$( \frac{1}{f * S ( L )} ) ,$$

the calculated modified JND step sizes using the present interpretation are approximately equal to modified JND step sizes calculated using the interpretation used for the PQ-EOTF.

In another arrangement, the modified Barten model is further multiplied by a JND multiples factor. The JND multiples factor is selected to correspond with the effective JND multiples factor that is known to be applied by the transfer function. For example, if the transfer function is the PQ-EOTF with a 12-bit encoding, the JND multiples factor is set to 0.9.

In another arrangement, the environment JND step size may be estimated in step 904 from the ambient luminance Lₛ and the representative luminance measure, including the average luminance L of a portion of the frame and a measured or assumed standard deviation σ of the portion of the frame. The purpose of using the standard deviation is to provide some safety margin to account for the samples in the portion of the frame being distributed over a wide range of values. Rather than calculating the environment JND step size corresponding to the average luminance L of the portion of the frame, in the present arrangement the environment JND step size is calculated for a modified luminance equal to the average luminance of the portion of the frame, plus a multiple g of the standard deviation, which may be expressed as (L+gσ). The term (L+gσ) is used in this implementation instead of L in Eqn. 2 above. Using the modified luminance (L+gσ) results in a smaller estimated environment JND step size (in percentage terms), compared to the environment JND step size estimated simply from L. By adjusting g, it is possible to tune the proportion of samples for which the desired JND step sizes are greater than or equal to the estimated environment JND step size. For example, when g=0 the desired JND step sizes of approximately half of the samples of the portion of the frame are greater than or equal to the estimated environment JND step size. When g=1 the desired JND step sizes of approximately 68.1% of the samples of the portion of the frame are greater than or equal to the estimated environment JND step size.

Control in the processor 205 of the method 900 then passes to a determine transfer function luminance step size step 906.

At the determine transfer function luminance step size step 906, the processor 205 is used to determine a luminance step size according to the transfer function, at the representative or average luminance derived from the determined frame portion, such as discussed above. The luminance step size may be estimated as the distance in absolute luminance between the average luminance of the portion of the frame, and the luminance corresponding to the next adjacent codeword. For example, if the transfer function is the PQ-EOTF 442 transfer function, with a bit depth of 10 bits exercising the codeword range 4-1019, and the average luminance of the portion of the frame is determined as 10.1 nits, the codeword corresponding to the average luminance is 309 and the next adjacent codeword is 310. The difference between the corresponding luminances is then calculated as 10.22779−10.10108=0.12671 nits. Control in the processor 205 of the method 900 then passes to a step size comparison step 908.

At the step size comparison step 908, the processor 205 compares the environment JND step size determined in step 904 with the transfer function luminance step size determined in step 906. If the transfer function luminance step size is less than or equal to the environment JND step size, this indicates that there is no evidence of inefficiency in the allocation of luminance levels to codewords (possibly even insufficient codewords are available for the viewing environment 300). In such a case, control in the processor 205 of the method 900 passes to an encode delta QP step 914.

Otherwise, in the case where the processor 205 executing step 908 determines that the environment JND step size of step 904 is greater than the transfer function luminance step size of step 906, there is deemed to be an over-allocation of codewords to represent luminance levels for the portion of the frame, under the environmental conditions. In such a case, it may be possible to increase the QP step size relative to the initial QP step size resulting from an initial QP value. This results in harsher quantisation of codewords in the spatial domain relative to the codeword quantisation implicit in the initial QP value, without any noticeable subjective impact (also relative to the subjective impact implicit in the codeword quantisation resulting from the initial QP value). The initial QP value is generally provided to the video encoder 118 as a parameter used to control the bit rate of the encoded bitstream 132 and the quality of the decoded video data, as shown on the display device 160. Alternatively, when ‘rate control’ is used, the video encoder 118 is provided with a target bit rate, from which a QP is determined that adapts to the video data to maximise quality while not exceeding the target bit rate. For the purposes of this disclosure, a QP determined using a rate control process is considered as an ‘initial QP’ that may be further adapted, e.g. according to the method 900.

The change in QP step size will result in a reduction locally in quality using measures such as PSNR. This is due to PSNR accounting for the differences between codewords provided to the video encoder 118 and codewords output from the video decoder 162 equally regardless of the subjective significance of errors in codewords in the decoded samples 170 compared codewords in the frame data 130. Subjective differences can result from frame location, environmental factors or absolute magnitude of the corresponding codewords. Notwithstanding such localised PSNR drop (which does not impact subjective quality), the reduced localised bit-rate allows the video encoder 118 to be configured to operate at a lower overall QP value, restoring the bit-rate to the level of a conventional encoder. Consequently, PSNR is increased in other areas of each frame, where the improvement is more likely to be perceptible to the human observer 302. Control in the processor 205 of the method 900 then passes to an adjust QP step 912.

At the adjust QP step 912, the processor 205 is used to adjust the value of QP by determining a QP for use locally, e.g. to encode the current CTU, being a local part of the frame being encoded.

In one arrangement of the method 900, the adjust QP step 912 results in the following operations being performed by the processor 205: A ratio between the environment JND step size and the transfer function luminance step size is determined. This ratio is indicative of the excessively finely quantised luminance levels provided by the PQ-EOTF 442 under the viewing environment 300 and relevant to the portion (i.e. CTU) of the frame under consideration. As discussed previously, QP approximates a power-law function with a power of two, with an increase in QP of six corresponding to a doubling of the quantisation step size. An amount by which to increase QP, known as delta QP (or ΔQP), is determined as follows:

$$Δ QP = ⌊ 6 {log}_{2} ( \frac{{l}_{JND}}{{l}_{tf}} ) + 0.5 ⌋ \qquad ( Eqn . 4 )$$

A final clipping may be applied to keep ΔQP within the range [−12,12], to comply with the range of the delta QP values afforded by the HEVC standard. A more restrictive limit of delta QP to no more than a lower fixed constant, such as six (corresponding to a doubling of the quantisation step size), is also advantageous. Such a limit provides protection against excessively harshly quantising codewords under extreme conditions. Moreover, as the intention is not to reduce the quantisation step size (i.e. decrease the quantisation parameter), generally clipping limits such as [0, 12] or [0, 6] would be applied.

In another arrangement of the step 912 of the method 900, the number of environment JND steps s_{JND} from the average luminance of the portion of the frame down to zero luminance is calculated. The number of environment JND steps may be calculated by iteratively subtracting JND step sizes calculated using Equation 3. The number of transfer function steps s_{tf} from the average luminance of the portion of the frame down to zero luminance is already known as it is equivalent to the corresponding codeword, plus some offset if the codeword range does not begin from zero. ΔQP may be determined as follows:

$$Δ QP = ⌊ 6 {log}_{2} ( \frac{{s}_{tf}}{{s}_{JND}} ) + 0.5 ⌋ \qquad ( Eqn . 5 )$$

In the present arrangement, ΔQPs calculated directly from Eqn. 5 exhibit a positive bias. Because the total number of s_{JND} steps is always less than the s_{tf} steps, ΔQP will be a positive value even when the average luminance of the portion of the frame is large. In an overall rate-distortion optimisation, constant bias in ΔQP does not affect the encoder's decisions. For example, if each CTU has ΔQP of two instead of zero, the rate-distortion tradeoffs between the CTUs are unchanged. However, signalling non-zero ΔQPs should be avoided as the signalling increases bitrate. In an alternative arrangement, the ΔQPs calculated from Eqn. 5 are further modified by subtracting an offset. The value of the offset may be equal to the ΔQP calculated when the average luminance of the portion of the frame is set equal to the ambient luminance.

In yet another arrangement of the step 912 of the method 900, a codeword is found, such that when applied to the transfer function the codeword selects a luminance with the difference to the luminance of the next lower codeword (i.e. the luminance of the codeword minus one), the difference corresponding to the determined environment JND step size. The ratio between the absolute luminance of the codeword and the luminance difference indicates the required number of codewords to encode all perceptible luminances down to darkness. The ratio between this required number of codewords and the actual codeword value, when greater than one, indicates the degree to which excessive codewords are provided by the PQ-EOTF 442. A delta QP is then determined to compensate for this ratio. Note that this method assumes linear step sizes from the average luminance down to zero, as opposed to a more accurate exponential decay model, however this model was found to provide an adequate result with reduced computational complexity.

In yet another arrangement of the step 912 of the method 900, a one-dimensional look-up table (LUT) is precomputed for determining ΔQP from the representative luminance derived from the determined frame portion, with an assumed ambient luminance (the LUT may be extended to two dimensions to allow various ambient luminances to be supported). The LUT may be precomputed for a small number of ambient luminances corresponding to standardised viewing conditions. For example, if the ambient luminance is 10 nits, and a LUT is used to replace the calculation of ΔQP from the ratio of the number of steps described in the above arrangement, the LUT is defined as follows:

| Representative luminance (cd/m²) | Delta QP |
|---|---|
| 0.45 and below | 6 |
| 0.65 | 5 |
| 1.0 | 4 |
| 1.5 | 3 |
| 2.6 | 2 |
| 4.4 | 1 |
| 10.0 and above | 0 |

For the PQ-EOTF 442, with 10-bit quantisation and using the video codeword range of 64-940, the corresponding LUT is:

| Codeword | Delta QP |
|---|---|
| 431 and below | 6 |
| 432 to 453 | 5 |
| 454 to 480 | 4 |
| 481 to 539 | 3 |
| 540 to 571 | 2 |
| 572 to 620 | 1 |
| 621 and above | 0 |

Note that delta QP is limited to a maximum of 6 in this LUT. Although with representative luminances further below 0.45 cd/m² it would be possible to derive delta QP values greater than 6, such representative luminances are sufficiently similar that this could result in unpredictable variations in the derived delta QP value. Limiting to a maximum value of 6 provides protection against such behaviour. Moreover, substantial bit-rate savings are already achieved with the doubling of the quantisation step size resulting from a delta QP value of 6.

Although the QP adjustment has a negative impact on measures such as PSNR operating in the codeword domain, other measures show gains. For example, the ‘delta E’ metric, configured to assume a reference white level of 100 nits results in gains as shown below. The delta E metric operates upon linear light using a custom model intended to more closely model human perception. Note that negative numbers represent a reduction in bit-rate vs. quality against ‘anchor’ results using the same test conditions, but without any QP adjustment. As can be seen, large gains are reported in nearly all cases, with an average reported gain of 21.5%.

| | | DE100 |
|---|---|---|
| class A | FireEaterClip4000r1 | −23.3% |
| | Market3Clip4000r2 | −6.2% |
| | SunRise | 1.6% |
| class B | BikeSparklers cut 1 | −14.2% |
| | BikeSparklers cut 2 | −16.1% |
| | GarageExit | −21.6% |
| class C | ShowGirl2Teaser | −27.6% |
| class D | StEM_MagicHour cut 1 | −44.0% |
| | StEM_MagicHour cut 2 | −31.6% |
| | StEM_MagicHour cut 3 | −32.1% |
| | StEM_WarmNight cut 1 | −39.9% |
| | StEM_WarmNight cut 2 | −32.6% |
| class G | BalloonFestival | −20.4% |
| class H | EBU_04_Hurdles | 4.4% |
| | EBU_06_Starting | −18.8% |
| Overall | | −21.5% |

Alternatively to calculating a delta QP to be applied regardless of the initial quantisation parameter value, the delta QP may be calculated using knowledge of the Quantcoeff module 706. For example, if an initial QP value is 12, then QP_rem is 0, resulting in selection of Quantcoeff table entry value 26214. An adjustment from the transfer function step size to the desired luminance step size requiring a 1.33× increase in inverse quantisation step size at the video decoder 162 corresponds to a 1/1.33×=0.75× change in quantisation step size at the video encoder 118. Scaling the value 26214×0.75 results in the value 19660. The entry in the Quantcoeff module 706 having the closest magnitude is the value 20560, at index position 2. Thus, a delta QP of 2 is required to adjust from the index 0 value to the index 2 value. To account for changes in QP_per, i.e. movements outside the range [0 . . . 5] for QP_rem, a corresponding doubling or halving of the values in the Quantcoeff module is applied for the purposes of determining delta QP. This compensates for the change in the right shift amount 726 resulting from the change in QP_per. Overall, this approach provides a finer precision selection of delta QP, as the actual integer nature of the implementation is taken into account, rather than the power function. In this case, derivation of delta QP depends on the initial QP value, in addition to the transfer function luminance step size, and the desired luminance step size according to the ambient environment.

In another arrangement of step 912 of the method 900, a codeword is found, such that when applied to the PQ-EOTF 442 the codeword selects a luminance with the difference to the luminance of the next lower codeword (i.e. the luminance of the codeword minus one), the difference corresponding to the determined environment JND step size. The ratio between the absolute luminance of the codeword and the luminance difference indicates the required number of codewords to encode all perceptible luminances down to darkness. The ratio between this required number of codewords and the actual codeword value, when greater than one, indicates the degree to which excessive codewords are provided by the PQ-EOTF 442. A delta QP is then determined to compensate for this ratio. Note that this method assumes linear step sizes from the average luminance down to zero, as opposed to a more accurate exponential decay model, however this model was found to provide an adequate result with reduced computational complexity.

The QP for each chroma TB is derived from the QP for the corresponding luma TB. A slice level QP offset for chroma is provided and experiments show that generally an offset of minus six (i.e. halve the quantisation step size relative to luma) provides substantial boost in objective and subjective quality for HDR contents. Although a slice level QP may be provided, excessive increase of the luma QP may cause artefacts in chroma, as the chroma encodes colour information and excessively harsh quantisation can introduce undesirable banding artefacts. Then, in another arrangement of step 912 of the method 900, a chroma QP offset is also applied to the CTU that ‘undoes’ the delta QP that was mainly intended to compensate for excessive luma (Y channel) bit rate. Although this signalling introduces a slight increase in bit rate, it provides a compensatory mechanism for any colour banding artefacts that may result from excessive increase in QP.

When step 912 is complete, control in the processor 205 for the method 900 then passes to the encode delta QP step 914.

At the encode delta QP step 914, the entropy encoder 624, under control of the processor 205, encodes a delta QP syntax element into the encoded bitstream 132. If no QP adjustment is required, then a value corresponding to zero are encoded, otherwise the sign and magnitude of the QP adjustment (e.g. from the adjust QP step 912) is encoded into the encoded bitstream 132. Control in the processor 205 for the method 900 then passes to an encode video data step 916.

At the encode video data step 916, the entropy encoder 624, under control of the processor 205, encodes remaining data associated with the considered CTU into the encoded bitstream 132. For example, residual coefficients associated with each TB of each RQT within the CTU are encoded. The method 900 then completes.

In other arrangements of the method 900, signalling representative of the ambient viewing environment 302 are stored in the encoded bitstream 132, e.g. using an ‘ambient viewing parameter supplementary enhancement information (SEI)’ message. This signalling indicates the intended viewing environment for the video data. Such signalling may enable the display device 160 to alter the viewing environment at the display to more closely match the viewing environment in which the mastering was performed.

In another arrangement of the method 900, the environment JND step size is based not only on the ambient viewing conditions, but also includes frame average luminance information, e.g. as computed by calculating an average luminance over the entire frame. Moreover, the average can be a running average over many preceding frames. Excluding the current frame from consideration avoids the need to buffer the current frame in the video encoder 118 prior to encoding (to compute the luminance over samples belonging to ‘future’ CTUs). As the correlation between successive frames of video data is very high, excluding the current frame from the calculation of this long-running average luminance has minimal effect on the resulting luminance value.

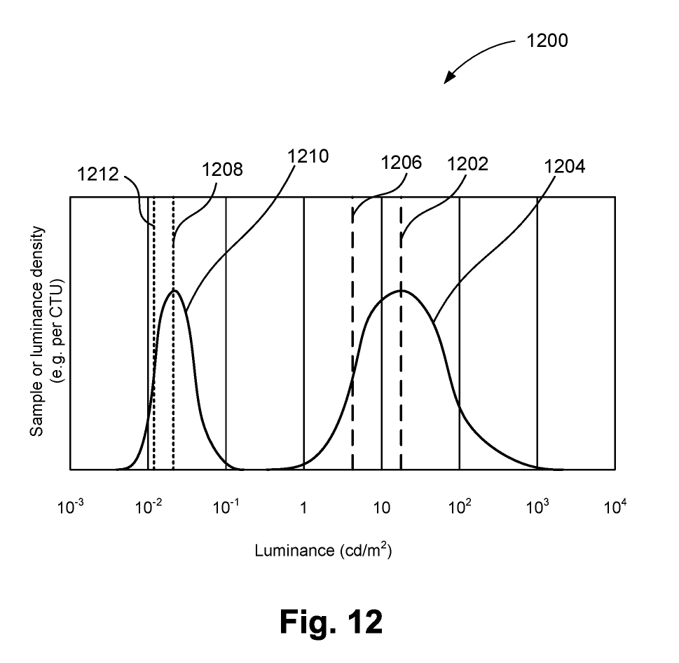

Arrangements where the environment JND step size are derived from a modified average luminance are described further with reference to FIG. 12 below.

FIG. 10 is a schematic flow diagram showing a method 1000 of decoding an encoded video bitstream using the video decoder 162. The method 1000 is suitable for decoding the encoded bitstream 132 that was produced using the method 900. Note that the method 1000 accords with the HEVC specification, for example when using the ‘Main’ or ‘Main 10’ profile of the HEVC specification. The method 1000 decodes the bitstream 132, resulting in outputting the decoded codewords 170 for display by the display device 160. The method 1000 begins with a decode QP step 1002.

At the decode QP step 1002, the entropy decoder 820, under control of the processor 205, decodes a syntax element from the encoded bitstream 132 indicative of the QP to be used in a current slice of a frame of the video data. Generally, each frame is stored in the encoded bitstream using a slice, or sequence of CTUs, however it is also possible to divide the frame into multiple slices. Control in the processor 205 for the method 1000 then passes to a decode delta QP step 1004.

At the decode delta QP step 1004, the entropy decoder 820, under control of the processor 205, decodes a delta QP syntax element from the encoded bitstream 132. The delta QP syntax element is generally decoded once per CTU, and is associated with the first TU of the CTU. It is possible to store delta QP syntax elements down to a configured depth in the CU hierarchy associated with the CTU. For example, the delta QP syntax element could be present for all TUs down to those associated with 16×16 CUs, to provide greater locality in the ability to alter QP, at the expense of increased bit rate. The effective QP for TUs coded after the delta QP syntax element is the sum of the decoded QP and the current and previously decoded delta QPs. Control in the processor 205 for the method 1000 then passes to a decode residual step 1006.

At the decode residual step 1006, the entropy decoder 820, under control of the processor 205, decodes the residual coefficients associated with the TUs associated with the CTU (i.e. with each CU in the CTU). Control in the processor 205 for the method 1000 then passes to an apply dequantisation step 1008.

At the apply dequantisation step 1008, the dequantiser 821, under control of the processor 205, uses the effective QP to dequantise the decoded residual coefficients (i.e. 850) to produce transform coefficients (i.e. 855). Control in the processor 205 for the method 1000 then passes to an apply inverse transform step 1009.

At the apply inverse transform step 1009, the inverse transform module 822, under control of the processor 205, performs an inverse transform operation upon the transform coefficients (i.e. 855) to produce the residual samples 856. Control in the processor 205 for the method 1000 then passes to a determine prediction step 1010.

At the determine prediction step 1010, the intra-frame prediction module 826 or the motion compensation module 834, under control of the processor 205, produce a block of predicted samples 866. The selection of either module is dependent on whether the CU is intra-predicted or inter-predicted, as signalled in the encoded bitstream 132. Control in the processor 205 for the method 1000 then passes to a reconstruct block step 1011.

At the reconstruct block step 1011, the summation module 824, under control of the processor 205, produces the reconstructed samples 858. The reconstructed samples 858 are produced by addition of the predicted samples 866 and the residual samples 856. The residual samples 856 correspond to codeword offsets relative to each predicted samples present in 866. As the residual samples 856 were produced according to a quantisation parameter, the residual samples 856 have an implicit step size according to the quantisation parameter and the basis functions of the inverse transform. Then, as the encoded bitstream 132 was produced according to the method 900, the residual samples have a step size dependent on the average luminance of a portion (i.e. CTU) of the current frame. The dependency is such that a greater step size is signalled where the JND luminance step between consecutive codewords is less than the JND step size for the human observer 302 watching the display device 160. Control in the processor 205 for the method 1000 then passes to an output image step 1012.

At the output image step 1012, the decoder 162 outputs the decoded codewords 170 under control of the processor 205, to the post-processing module 164. The drive signal 172 is determined from the decoded codewords 170 according to the post-processing module 164. The post-processing module 164 may leave the decoded codewords 170 unattenuated, or may make necessary adjustments such that the panel device 166 produces luminance output for each pixel according to the PQ-EOTF 442. Colour space conversions or chroma sampling rate conversions may also be performed, depending on the nature of the encoded bitstream 132. Once the post-processing module 164 has completed any required tasks, the drive signal is output to the panel device 166, resulting in visual reproduction of the video data. The method 1000 then terminates.

In one arrangement of the method 1000, an average approximate luminance is determined from the predicted samples 866. As the predicted samples 866 do not include the residual samples 856, only an approximation of the actual average luminance can be derived in the video decoder 162, however the residual samples 856 are signed and generally have a mean value close to zero, so relatively low deviation from the average luminance 136 as input to the video encoder 118, is expected. Then, the average approximate luminance is used to calculate a second delta QP value, which is applied in addition to the signalled delta QP when calculating the QP for TBs in a given CTU. Such arrangements provide for reduced bit rate as the video encoder 118 is not required to explicitly signal delta QP for the purpose of reducing bit rate without affecting subjective quality. However, delta QP signalling may still be used for other purposes, such as rate control. In such arrangements, the method 900 is similarly modified such that the dequantiser 626 and the inverse transform 628 produce residual samples 668 corresponding to the residual samples 856 as seen in the video decoder 162.

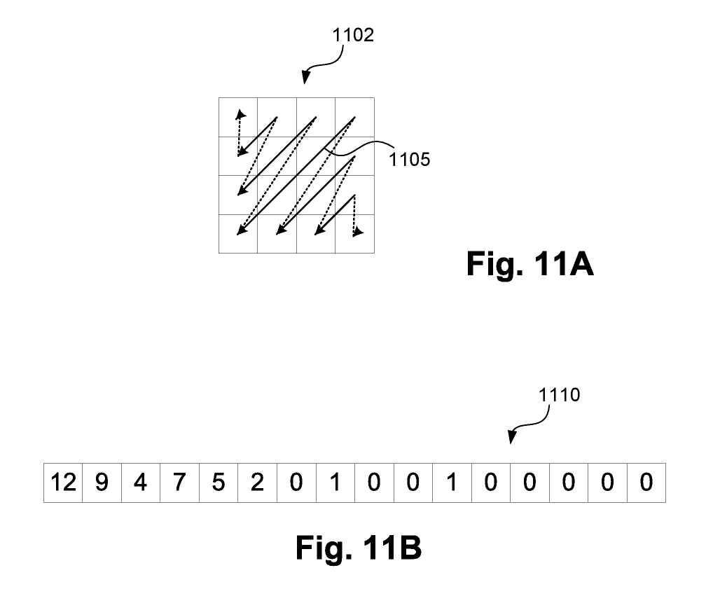

FIGS. 11A and 11B schematically represent a method known as ‘rate-distortion optimised quantisation’ (RDOQ), performed in the video encoder 118 for selecting residual coefficients for a TB. As discussed with reference to FIG. 6, the quantiser module 622 produces quantised transform (or residual) coefficients 664 from the transform coefficients 662 by applying a quantisation parameter. In an arrangement of the video encoder 118, the RDOQ process is modified according to the method 900. In particular, when the step size comparison step 908 indicates that the environment JND step size is greater than the transfer function JND step size, RDOQ is performed as follows: The residual coefficients of a transform block, e.g. 1102 in FIG. 11A are scanned according to a scan pattern, e.g. 1105, to produce a residual coefficient array 1110 seen in FIG. 11B. Instead of directly encoding the residual coefficient array 1110, a modified trellis search is performed. A test of decrementing each residual coefficient in the array 1110 is performed. The bit-rate cost of coding the residual coefficient array 1110 with the decremented residual coefficient is compared with the resulting distortion introduced into the residual samples using a Lagrangian parameter. If the result shows an improvement compared to the residual coefficients initially produced by the quantiser module 622, the modified residual coefficient is selected for encoding into the encoded bitstream 132. This process is repeated for each nonzero residual coefficient in the residual coefficient array 1110. The impact on bit rate of decrementing a given residual coefficient depends on the magnitude of the residual coefficient, state information in the entropy encoder module 624, and whether the residual coefficient is the last nonzero coefficient in the scanning order. As the bit rate is dependent on the residual coefficient magnitudes, a reduction in magnitude can lead to a reduction in bit rate. Note that in the RDOQ process applied when the environment JND step size is equal to or less than the transfer function JND step size, the RDOQ process is ‘symmetric’, i.e. both incrementing and decrementing of residual coefficients is tested. The bias towards reducing residual coefficient magnitude in the opposite case reduces bit rate without affecting subjective quality perceived by the human observer 302. As RDOQ does not require the introduction of any new signalling into the encoded bitstream 132 (just modification of residual coefficients) the modified method is performed in the video encoder 118, with the video decoder 162 decoding the resulting encoded bitstream 132 according to the conventional processes of HEVC.

FIG. 12 includes a graph 1200 showing various statistical distributions of luminance over a portion of a frame of video data. The graph 1200 shows luminances over the range afforded by the PQ-EOTF 442. Two example distributions, 1204 (a bright CTU) and 1210 (a dark CTU) are shown. Each of the distributions 1204 and 1210 is shown as a normal distribution, although in practice a considerable degree of variation can be expected. The distribution 1204 has an associated mean 1202 and the distribution 1210 has an associated mean 1208. A particular environment JND step size may be derived using these means, however there is a risk that the resulting step size is excessively high for part of the signal occupying the portion of the frame data. Thus, adjusted means, e.g. 1206 and 1212 respectively, are computed by assuming a particular standard deviation present in the distributions 1204 or 1210 from the means 1202 or 1208. The adjusted means, i.e. 1206 or 1212, are used to determine the environment JND step size. This results in a smaller step size compared to using the means 1202 or 1208, and thus a reduced level for the QP increment. Note that generally for the ‘bright’ CTU, no adjustment of the QP is expected (i.e. the resulting JND threshold derived from 1206 should be less than or equal to the transfer function JND threshold). The adjusted means, e.g., 1206 or 1212, can be calculates as one standard deviation below the determined means, e.g. 1202 or 1208. Alternatively, the worst case, i.e. the case resulting in the minimum JND step size (either above or below 1202 or 1208) can be used. Selecting such a worst case limits the achievable bit rate reduction, but protects against the possibility of introducing undesirable banding artefacts when displaying the decoded codewords 170. Although an example of one standard deviation was used, other differences are also possible, representing a trade-off between the expectation that the underlying codewords may deviate substantially from a normal distribution vs minimising the bit rate of the portion of the frame data when encoded in the video bitstream 132. In arrangements where more detailed statistical information is available, e.g. via a histogram of codewords values, a more accurate deviation can be derived. A representative luminance is chosen based upon the average and the standard deviation derived from the data. Arrangements with a histogram of luminance values, or codeword values, can produce a representative luminance value even when the distribution of codewords deviates far from a normal distribution. In some cases, an average is not overly representative of the portion of video data. For example, when displaying a dark scene with bright pin-point light sources, such as a star field, the average is representative neither of the dark background nor the pin-point light sources. Usage of a median luminance level or median codeword value can provide a more representative value compared to an average value.

Although the portion of the video frame for which a representative luminance is derived is generally one CTU, other regions are also possible. For example, a representative luminance may be derived over different division of each frame into groups of CTUs. Example groupings include slices (arbitrary collections of CTUs, each collection being sequential in a CTU scanning order) or ‘wavefronts’ (a separation of each frame into rows of CTUs to increase parallel processing capability).

In an arrangement of the video processing system 100 providing encoding of video data that is responsive to the display environment, the ambient light sensor 114 is located in the display device 160 and the ambient environment illumination 134 is communicated back to the encoding device 110 via the communication channel 150. The video encoder 118 uses this information from the display device 160 when encoding video data, e.g. in accordance with the method 900. A video conferencing or telepresence system is an example of a system upon which this arrangement could be practised.

Arrangements disclosed herein provide for a video system that encodes and decodes video content at a particular subjective quality level that has reduced bit rate compared to conventional video encoders. Moreover, such arrangements allow for an overall increase in the quality level by exploiting the reduction in bit rate afforded by such methods.

### INDUSTRIAL APPLICABILITY

The arrangements described are applicable to the computer and data processing industries and particularly for the digital signal processing for the encoding a decoding of signals such as video signals.

The foregoing describes only some embodiments of the present invention, and modifications and/or changes can be made thereto without departing from the scope and spirit of the invention, the embodiments being illustrative and not restrictive.

The claims defining the invention are as follows:

1. A method of encoding a portion of a video frame into a video bitstream, the portion of the video frame containing samples, the samples representing luminance levels according to an electro-optical transfer function (EOTF), the method comprising:
determining a luminance of the portion of the video frame;
determining a desired luminance step size, the desired luminance step size being a just noticeable difference (JND) determined according to the determined luminance and a predetermined ambient luminance, the desired luminance step size being greater than a luminance step size from the EOTF;
determining a quantisation parameter from the desired luminance step size and the luminance step size from the EOTF, the quantisation parameter being used for encoding the portion of the video frame; and
encoding the portion of the video frame into the video bitstream according to the determined quantisation parameter.

2. A method according to claim 1, wherein the portion of the video frame corresponds with one coding tree unit.

3. A method according to claim 1, wherein quantisation parameter is determined from a provided quantisation parameter such that a quantisation step size is adjusted according to a ratio between the desired luminance step size and the luminance step size from the EOTF.

4. A method according to claim 1, wherein the EOTF is the PQ-EOTF.

5. A method according to claim 1, wherein the ambient luminance is also encoded into the video bitstream.

6. A method according to claim 1, wherein the luminance step size from the EOTF is determined using the Barten contrast sensitivity function (CSF) adjusted for differences between a representative luminance value and the ambient luminance.

7. A method according to claim 1, wherein the luminance step size from the EOTF is determined using the Barten contrast sensitivity function (CSF) adjusted for differences between a representative luminance value and the ambient luminance, the representative luminance comprising one of an average luminance or a modified luminance based on the average luminance and a standard deviation.

8. A method according to claim 1, wherein the quantisation parameter (QP) is adjusted using a delta quantisation parameter.

9. A method according to claim 1 wherein the quantisation parameter (QP) is adjusted using a delta quantisation parameter, and the QP is adjusted for each portion of the video frame and encoded into a transform unit of the bitstream.

10. A method according to claim 1, wherein the quantisation parameter (QP) is adjusted using a delta quantisation parameter, and the adjusting of the quantisation parameter includes adjusting one or more quantisation matrices.

11. A video system, comprising:
a video encoder arranged to encode at least a portion of a video frame into a video bitstream, the portion of the video frame containing samples representing luminance levels according to an electro-optical transfer function (EOTF), the encoder being operable to:
determine a luminance of the portion of the video frame;
determine a desired luminance step size, the desired luminance step size being a just noticeable difference (JND) determined according to the determined luminance and a predetermined ambient luminance, the desired luminance step size being greater than a luminance step size from the EOTF;
determine a quantisation parameter from the desired luminance step size and the luminance step size from the EOTF, the quantisation parameter being used for encoding the portion of the video frame; and
encode the portion of the video frame into the video bitstream according to the determined quantisation parameter;
a path by which the video bitstream is conveyed; and
at least one video decoder operable to decode the video bitstream conveyed by the path and to provide a decoded video signal for reproduction upon panel device.

12. A non-transitory computer readable storage medium having a program recorded thereon, the program being executable by a processor to encode a portion of a video frame into a video bitstream, the portion of the video frame containing samples, the samples representing luminance levels according to an electro-optical transfer function (EOTF), the program comprising:
code for determining a luminance of the portion of the video frame;
code for determining a desired luminance step size, the desired luminance step size being a just noticeable difference (JND) determined according to the determined luminance and a predetermined ambient luminance, the desired luminance step size being greater than a luminance step size from the EOTF;
code for determining a quantisation parameter from the desired luminance step size and the luminance step size from the EOTF, the quantisation parameter being used for encoding the portion of the video frame; and
code for encoding the portion of the video frame into the video bitstream according to the determined quantisation parameter.

13. A non-transitory computer readable storage medium according to claim 12, wherein the portion of the video frame corresponds with one coding tree unit.

14. A non-transitory computer readable storage medium according to claim 12, wherein quantisation parameter is determined from a provided quantisation parameter such that a quantisation step size is adjusted according to a ratio between the desired luminance step size and the luminance step size from the EOTF.

15. A non-transitory computer readable storage medium according to claim 12, wherein the EOTF is the PQ-EOTF.

16. A non-transitory computer readable storage medium according to claim 12, wherein the ambient luminance is also encoded into the video bitstream.

17. A non-transitory computer readable storage medium according to claim 12, wherein the luminance step size from the EOTF is determined using the Barten contrast sensitivity function (CSF) adjusted for differences between a representative luminance value and the ambient luminance, the representative luminance comprising one of an average luminance or a modified luminance based on the average luminance and a standard deviation.

18. A non-transitory computer readable storage medium according to claim 12, wherein the quantisation parameter (QP) is adjusted using a delta quantisation parameter.

19. A non-transitory computer readable storage medium according to claim 12, wherein the quantisation parameter (QP) is adjusted using a delta quantisation parameter, and the QP is adjusted for each portion of the video frame and encoded into a transform unit of the bitstream.

20. A non-transitory computer readable storage medium according to claim 12, wherein the quantisation parameter (QP) is adjusted using a delta quantisation parameter, and the adjusting of the quantisation parameter includes adjusting one or more quantisation matrices.
